(19) United States
(12) Patent Application Publication
(10) Pub. No.: US 2010/0226377 A1
(43) Pub. Date: Sep. 9, 2010

(54) Communication System, Node, Terminal and Communication Method and Program

(75) Inventors: Daisaku Ogasahara, Tokyo (JP); Masahiro Sakauchi, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 12/227,182

(22) PCT Filed: May 8, 2007
(86) PCT No.: PCT/JP2007/059492

§ 371 Date: Nov. 10, 2008

(30) Foreign Application Priority Data
May 9, 2006 (JP) 2006-130807

(51) Int. Cl. H04L 12/56

(52) U.S. Cl. 370/400

(57) ABSTRACT

It is possible to increase the communication system transmission capacity flexibly and at low cost in accordance with a communication system traffic amount. A terminal connected to a plurality of networks distributes a plurality of frame segments generated by dividing a single frame to the plurality of networks connected to the local terminal transmits them. Further, the terminal reconstructs the original frame from the plurality of frame segments generated by dividing the single frame. It should be noted that each of the frame segments contains division configuration information indicating how the frame has been divided (the number of divisions and the order of the frame segments) and also contains information required for performing MAC address learning for determining the path to the destination terminal.

### TECHNICAL FIELD

The present invention relates to a communication system, a node, a terminal, and a communication method and program and, more particularly, to a communication system having high scalability on transmission capacity and a terminal, a node, a communication method, a terminal program, and a node program for use in realizing the communication system.

### BACKGROUND ART

In recent years, data traffic has been explosively increased due to the recent rapid expansion of the Internet and, therefore, transmission capacity of a backbone communication system has been insufficient to support the increased traffic demand. When the transmission capacity of the communication system becomes insufficient, congestion frequently occurs, resulting in intermittent communication or disruption of communication. Thus, there is demanded a technique capable of increasing transmission capacity of a communication system so as to continuously provide stable communication.

Generally, in order to increase the transmission capacity of an existing communication system, a communication apparatus having a communication interface using optical components or electrical components operating at a higher bit rate is used to construct a new communication system having a larger transmission capacity.

However, a high-speed communication interface is very expensive, which significantly increases the construction cost of a communication system. In particular, in the case where it is difficult to estimate future change in traffic amount, there is no choice but to use a communication interface operating at the highest speed among currently-available communication interfaces, which further increases the construction cost. Further, the communication system lacks diversity in terms of its speed setting, so that even if it is possible to estimate the transition of the future change in traffic amount, it is likely that a communication interface operating at a speed far exceeding the estimated speed is forced to be used, resulting in occurrence of unnecessary cost.

As a technique for solving the above problem, there is considered a technique in which a plurality of low-cost and low-speed interfaces are used to realize a communication system having high scalability capable of increasing its transmission capacity in accordance with the traffic amount.

Hereinafter, a technique for constructing a communication system having high scalability will be described with a network (hereinafter, referred to as “RPR network”) to which an RPR (Resilient Packet Ring) disclosed in Non-Patent Document 1 has been applied taken as an example of a network for realizing a highly reliable backbone communication system. The Non-Patent Document 1 is a standardization document issued by the IEEE (the Institute of Electrical and Electronics Engineers) in 2004.

FIG. 24 is an explanatory view showing an example of the RPR network. The RPR is a network protocol for transferring a frame (packet) on a ring topology network as shown in FIG. 24.

In a communication system shown in FIG. 24, four nodes (hereinafter, referred to as “RPR node”) operating according to the RPR constitutes an RPR network 70, and one terminal is located under each RPR node. To locate one terminal under the RPR node means that a terminal that does not belong to a ring network to which the RPR node belongs is connected to the RPR node. The terminal may belong to a ring network other than one to which the RPR node to which the terminal is connected belongs or may belong to another communication network. The terminal located under the RPR node is hereinafter sometimes referred to merely as “dependent terminal”.

In the example of FIG. 24, each of the nodes 700 to 730 has ports P1 to P3. Each of the nodes 700 to 730 uses the ports P1 and P2 to exchange an RPR frame with its adjacent RPR nodes. Further, each of the RPR nodes 700 to 730 has its dependent terminal (one of terminals 910 to 930). Each RPR node and its dependent terminal use the port P3 of the RPR node and a port (not shown) of the dependent terminal, respectively, to exchange a frame (user frame).

As a main feature of the RPR, a high speed protection function is known. For example, in the case where a link between the RPR nodes is disconnected in the RPR network, the RPR nodes located at both ends of the link detect the disconnection and promptly notify all the other RPR nodes of the corresponding information. The RPR nodes that have received the notification about the disconnection transits to an operating state of controlling the traffic (communication direction, TTL, and the like) and allows a transmitted frame to bypass the disconnected portion, whereby communication can be continued. The protection function is a function for preventing communication from being interrupted by a failure occurring in a given location on the network.

The RPR is designed to be applied to a backbone communication system, such as an urban communication network, that handles a large amount of traffic such that communication can be restored in as quickly as 50 ms or less, which is equivalent to a transmission technique like SDH (Synchronous Digital Hierarchy) or SONET (Synchronous Optical Network), whereby a highly reliable communication system can be constructed.

Further, as a technique for increasing the transmission capacity of an RPR network in operation, there is known LAG (Link Aggregation) which is disclosed in, e.g., Non-Patent Document 2. The Non-Patent Document 2 is also a standardization document issued by the IEEE.

The LAG is a technique that virtualizes a plurality of physical ports into one logical port. In other words, the LAG virtualizes a plurality of links into one logical link. When the LAG is applied, traffic is transmitted in a divided manner to a plurality of physical links belonging to the logical link in normal operation time where failure is not detected, thereby increasing the communication band of the link (up to a total sum of the communication bands of all the physical links).

FIG. 25 is an explanatory view showing an example in which the LAG is applied to the RPR network. In a system shown in FIG. 25, the LAG is applied between RPR nodes belonging to an RPR network 70 and between the RPR nodes and their dependent terminals. In the example of FIG. 25, each of RPR nodes 700 to 730 belonging to the RPR network 70 has LAG-applied ports P1 to P6 to which the LAG has been applied for duplicating the ports P1 to P3 of each RPR node in FIG. 24. Further, each of terminals 900 to 930 located under each of the RPR nodes 700 to 730 has LAG-applied ports P1 and P2 for duplicating the ports P1 of each dependent terminal in FIG. 24. With this configuration, a plurality of links between the respective RPR nodes belonging to the RPR network 70 and a plurality of links between the RPR nodes and their dependent terminals can be virtualized into one link, respectively, and traffic can be distributed into a plurality of links constituting a virtual link. As described above, the transmission capacity of a communication system can be increased.

Patent Document 1 discloses a communication apparatus having a multilink function that provides a plurality of links as one virtual line like the abovementioned LAG. The multilink communication apparatus disclosed in Patent Document 1 has a link monitoring function in a multilink processing section 14 thereof and sorts communication traffic into a plurality of transmitting and receiving sections provided therein based on the monitoring result.

According to such a technique that virtualizes a plurality of links into one link, by increasing the number of physical links in accordance with the traffic amount, a communication system having a desired traffic capacity can be constructed.

Further, there is known a technique in which a plurality of communication paths including one or more relay nodes is used to increase the communication band between terminals (refer to, e.g., Patent Document 2). A plural line use information transfer apparatus disclosed in Patent Document 2 is located between a communication medium and a communication user on both receiving side and transmitting side. The transmitting-side plural line use information transfer apparatus divides a packet that has received from the communication user from the head into a number corresponding to the number of communication mediums used for simultaneous parallel transfer and adds destination information to the obtained respective packets to constitute a plurality of frames. The transmitting-side plural line use information transfer apparatus then transfers the obtained frames to the receiving-side plural line use information transfer apparatus via the plurality of communication mediums.
Patent Document 1: JP 2000-216815-A (column 0014 to 0016, FIG. 1)
Patent Document 2: JP 2000-216791-A (column 0010 to 0013, FIG. 1)
Non-Patent Document 1: “IEEE Std. 802.17 Part 17: Resilient packet ring (RPR) access method and physical layer specifications”, IEEE Inc, 2004, p. 27-54
Non-Patent Document 2: “IEEE Std. 802.3ad Amendment to Carrier Sense Multiple Access with Collision Detection (CSMA/CD) Access Method and Physical Layer Specifications—Aggregation of Multiple Link Segments”, IEEE Inc, 2000, p. 95-107

### DISCLOSURE OF THE INVENTION

### Problems to be Solved by the Invention

However, the above conventional techniques have the following problems. In the case where a technique like the LAG technique disclosed in Non-Patent Document 1 or multilink function disclosed in Patent Document 1, i.e., a technique that virtualizes a plurality of links into one link is employed, a port for connecting a plurality of links needs to previously be provided in all the RPR nodes and all their dependent terminals. Therefore, if a future increase in the traffic amount cannot be estimated at the construction time of a communication system, it is difficult to realize an adequate communication system.

For example, in the case where the number of ports has become insufficient because of a larger-than-expected increase in the traffic amount, an RPR network and terminals having more ports need to be prepared to construct a new communication system, as well as the existing communication system cannot effectively be utilized, resulting in an increase in system construction cost.

Further, for example, in the case where an excessive number of ports are provided in the RPR nodes and their dependent terminals, switching processing capability and frame multiplexing capability commensurate with the number of ports for use in the communication band of the link are required. That is, very expensive communication devices are required. If processing capability commensurate with the number of ports is not provided, the processing speed becomes insufficient to cause congestion with the result that a frame unable to be processed is discarded.

Further, in the case where the technique (including the technique disclosed in Patent Document 2) that virtualizes a plurality of communication paths into one communication path is employed, when the number of terminals becomes increased, the number of settings for the path becomes tremendous in some link topologies, which places heavy burden on a communication system administrator.

For example, in a communication system in which communication is performed via an inter-switch link in which a communication path to be used is always determined, such as IP (Internet Protocol), MPLS (Multi-protocol Label Switching), and SONET, respective terminals need to be connected in full mesh. Thus, assuming that the number of RPR networks is M and the number of terminals is N, the number of paths set among the terminals is represented by M×N×(N−1). For example, assuming that the communication system shown in FIG. 24 is an MPLS network, the number of paths becomes 12 (6 for transmission and 6 for reception). If the number of RPR networks is increased to 2, the number of MPLS paths doubles, e.g., 24 paths.

Further, in the case where a currently widely used Ethernet frame (Ethernet is registered trademark) is employed, not only an overhead due to division of the Ethernet frame, but also an overhead due to encapsulation of frame segments into a frame of a protocol for managing the path is caused, with the result that increasing efficiency of the transmission capacity may significantly decreased.

The present invention has been made in view of the problems residing in the abovementioned conventional techniques, and an object thereof is to provide a communication system having high scalability and capable of flexibly realizing a desired transmission capacity at low cost and a terminal, a node, a communication method, a terminal program, and a node program for use in realizing the communication system.

### Means for Solving the Problems

According to the present invention, there is provided a communication system in which a terminal is connected to a plurality of networks. The terminal is connected to a node belonging to each network as a dependent terminal to use the plurality of networks as a communication path. The terminal includes: a frame segment generation means for generating a plurality of frame segments obtained by dividing a single frame, each of the frame segments storing a destination node identifier for identifying a destination terminal of the frame and a transmission source node identifier for identifying a transmission source terminal of the frame; a frame segment distribution means for distributing the frame segments generated by the frame generation means to all or part of the nodes to which the terminal is connected and transmitting them; and a frame reconstruction means for reconstructing a frame before division from a plurality of frame segments which are received from a node to which the terminal is connected and which are generated by the frame segment generation means provided in a different terminal from the terminal. The node to which the terminal is connected includes: a correspondence relationship storage means for storing information indicating a correspondence relationship between a terminal and a node to which the terminal is connected as a dependent terminal; an intra-network communication frame generation means for generating, when receiving the frame segment from its dependent terminal, an intra-network communication frame storing the received frame segment in the payload after determining a transfer method or transfer destination node based on the destination node identifier stored in the frame segment and the correspondence relationship between the terminal indicated by the destination node identifier and node which is stored in the correspondence relationship storage means and storing a node identifier for identifying the node as a transmission source address; and a frame segment extraction means for extracting the frame segment stored in the payload of the received intra-network communication frame and registering, in the correspondence relationship storage means, information indicating the correspondence relationship between the node indicated by the transmission source address of the intra-network communication frame and terminal indicated by the transmission source node identifier stored in the extracted frame segment.

Further, according to the present invention, there is provided a communication system in which a terminal is connected to a plurality of networks. The terminal is connected to a node belonging to each network as a dependent terminal to use the plurality of networks as a communication path. The terminal includes: a correspondence relationship storage means for storing information indicating a correspondence relationship between a terminal and a node to which the terminal is connected as a dependent terminal; a frame segment generation means for generating a plurality of frame segments obtained by dividing a single frame, each of the frame segments storing a destination node identifier for identifying a destination terminal of the frame and a transmission source node identifier for identifying a transmission source terminal of the frame; an intra-network communication frame generation means for generating, for each frame segment generated by the frame segment generation means, an intra-network communication frame storing the frame segment in the payload after determining a transfer method or transfer destination node based on the destination node identifier stored in the frame segment and the correspondence relationship between the terminal indicated by the destination node identifier and node which is stored in the correspondence relationship storage means and storing a node identifier for identifying a node to which the terminal is connected as a transmission source address; a frame segment distribution means for distributing the intra-network communication frames generated by the intra-network communication frame generation means to all or part of the nodes to which the terminal is connected and transmitting them; a frame segment extraction means for extracting the frame segment stored in the payload of the received intra-network communication frame and registering, in the correspondence relationship storage means, information indicating the correspondence relationship between the node indicated by the transmission source address of the intra-network communication frame and terminal indicated by the transmission source node identifier stored in the extracted frame segment; and a frame reconstruction means for reconstructing a frame before division from a plurality of frame segments extracted by the frame segment extraction means.

The frame segment generation means may add, to each of the frame segments that store data segment which are generated by dividing a single frame, frame segment information indicating information required for integrating the data segment so as to reconstruct the original frame so as to generate the frame segments.

The frame segment generation means may add, to each of the frame segments, frame segment information including a frame identifier for identifying a frame based on which each of the frame segments is generated and division number information for recognizing the number of frame segments generated from the same frame and division order of the frame segments so as to generate the frame segments.

The frame segment generation means may generate the frame segments such that the frame length of each of the frame segments generated from a single frame is proportional to the transmission capacity of a network to which each of the frame segments is transmitted.

The frame segment generation means may generate the frame segment such that the frame length of each of the frame segments generated from a single frame has a predetermined value.

The frame segment generation means may change the number of frame segments to be generated based on the availability of a communication link in the network to which a node connected to the terminal belongs.

The frame segment distribution means may change the network to which each of the frame segments is distributed based on the availability of a communication link in the network to which a node connected to the terminal belongs.

The intra-network communication frame generation means may delete part or all of the data which are stored, in an overlapped manner, in all the frame segments generated by dividing a single frame when the data are not deleted by another node that receives any of the frame segments.

When detecting that communication with another node constituting the network to which the local node belongs is disabled, the node may notify its dependent terminal of the corresponding information.

The nodes that belong to different networks and having the same dependent terminal may operate such that the intra-network communication frames, which store the frame segments generated from the same frame and which are distributed to the respective different networks, are transferred from the transmission source node to destination node in the same amount of time. To operate such that the intra-network communication frames are transferred from the transmission source node to destination node in the same amount of time is to determine the transfer path according to a previously set determination method of the transfer path such that the transfer paths of the frame segments in the respective networks coincide with each other.

The nodes that belong to different networks and having the same dependent terminal may notify each other of topology information indicating the topology of the network to which the each of the nodes belong.

The node may determine a transfer path of the intra-network communication frame distributed to the network to which the local node belongs such that the intra-network communication frames, which store the frame segments generated from the same frame and which are distributed to the respective different networks, are transferred from the transmission source node to destination node in the same amount of time based on the topology information of the network to which the local node belongs and topology information of another network to which another node having the same dependent terminal as the local node has belongs.

The node may suspend, for a certain period of time, transmission of the intra-network communication frame distributed to the network to which the local node belongs such that the intra-network communication frames, which store the frame segments generated from the same frame and which are distributed to the respective different networks, are transferred from the transmission source node to destination node in the same amount of time.

The frame segment generation means may make the frame lengths of the frame segments generated by dividing a single frame proportional to the transmission capacities of the networks to which the frame segments are distributed.

The frame segment generation means may change the frame lengths of the frame segments generated by dividing a single frame in accordance with the degree of congestion in the respective networks.

The frame segment distribution means may distribute the frame segments such that the communication bandwidths of the traffic transmitted to the respective networks are proportional to the transmission capacities of the respective networks.

The frame segment distribution means may change the communication bandwidths of the traffic transmitted to the respective networks in accordance with the degree of congestion in the respective networks.

The frame segment reconstruction means may include: a frame segment storage means for storing the frame segments; and a frame segment management means for managing the frame segments stored in the frame segment storage means. To manage the stored frame segments is, e.g., to allow the presence/absence of the stored frame segments and storage positions thereof to be referenced by associating information for identifying the frame segments with storage positions thereof.

The frame segment management means may manage the frame segments by associating the transmission source identifier of the frame segments, frame identifier for identifying a frame based on which the frame segments are generated, storage position of the frame segments in the frame segment storage means, and the number of frames of the frame segment that has already been stored in the frame segment storage means from a plurality of frame segments generated from the same frame as the frame segment.

Further, according to the present invention, there is provided a terminal used in a communication system in which the terminal is connected to a plurality of networks. The terminal is connected to a node belonging to each network as a dependent terminal to use the plurality of networks as a communication path. The terminal includes: a frame segment generation means for generating a plurality of frame segments obtained by dividing a single frame, each of the frame segments storing a destination node identifier for identifying a destination terminal of the frame and a transmission source node identifier for identifying a transmission source terminal of the frame; a frame segment distribution means for distributing the frame segments generated by the frame generation means to all or part of the nodes to which the terminal is connected and transmitting them; and a frame reconstruction means for reconstructing a frame before division from a plurality of frame segments which are received from a node to which the terminal is connected and which are generated by the frame segment generation means provided in a different terminal from the terminal.

Further, according to the present invention, there is provided a terminal used in a communication system in which the terminal is connected to a plurality of networks. The terminal is connected to a node belonging to each network as a dependent terminal to use the plurality of networks as a communication path. The terminal includes: a correspondence relationship storage means for storing information indicating a correspondence relationship between a terminal and a node to which the terminal is connected as a dependent terminal; a frame segment generation means for generating a plurality of frame segments obtained by dividing a single frame, each of the frame segments storing a destination node identifier for identifying a destination terminal of the frame and a transmission source node identifier for identifying a transmission source terminal of the frame; an intra-network communication frame generation means for generating, for each frame segment generated by the frame segment generation means, an intra-network communication frame storing the frame segment in the payload after determining a transfer method or transfer destination node based on the destination node identifier stored in the frame segment and the correspondence relationship between the terminal indicated by the destination node identifier and node which is stored in the correspondence relationship storage means and storing a node identifier for identifying a node to which the terminal is connected as a transmission source address; a frame segment distribution means for distributing the intra-network communication frames generated by the intra-network communication frame generation means to all or part of the nodes to which the terminal is connected and transmitting them; a frame segment extraction means for extracting the frame segment stored in the payload of the received intra-network communication frame and registering, in the correspondence relationship storage means, information indicating the correspondence relationship between the node indicated by the transmission source address of the intra-network communication frame and terminal indicated by the transmission source node identifier stored in the extracted frame segment; and a frame reconstruction means for reconstructing a frame before division from a plurality of frame segments extracted by the frame segment extraction means.

Further, according to the present invention, there is provided a node used in a communication system in which a terminal is connected to the node belonging to each network as a dependent terminal to use the plurality of networks as a communication path. The node to which the terminal is connected includes: a correspondence relationship storage means for storing information indicating a correspondence relationship between a terminal and a node to which the terminal is connected as a dependent terminal; an intra-network communication frame generation means for generating, when receiving the frame segment from its dependent terminal, an intra-network communication frame storing the received frame segment in the payload after determining a transfer method or transfer destination node based on the destination node identifier stored in the frame segment and the correspondence relationship between the terminal indicated by the destination node identifier and node which is stored in the correspondence relationship storage means and storing a node identifier for identifying the node as a transmission source address; and a frame segment extraction means for extracting the frame segment stored in the payload of the received intra-network communication frame and registering, in the correspondence relationship storage means, information indicating the correspondence relationship between the node indicated by the transmission source address of the intra-network communication frame and terminal indicated by the transmission source node identifier stored in the extracted frame segment.

Further, according to the present invention, there is provided a communication method applied to a communication system provided with a plurality of networks, in which a terminal is connected to a node belonging to each network as a dependent terminal to use the plurality of networks as a communication path. The method includes: generating a plurality of frame segments obtained by dividing a single frame, each of the frame segments storing a destination node identifier for identifying a destination terminal of the frame and a transmission source node identifier for identifying a transmission source terminal of the frame; distributing the generated frame segments to all or part of the connected nodes and transmitting; reconstructing a frame before division from a plurality of frame segments which are received from the node; storing information indicating a correspondence relationship between a terminal and a node to which the terminal is connected as a dependent terminal; generating, when receiving the frame segment from its dependent terminal, an intra-network communication frame storing the received frame segment in the payload after determining a transfer method or transfer destination node based on the destination node identifier stored in the frame segment and the stored correspondence relationship between the terminal indicated by the destination node identifier and node and storing a node identifier for identifying the node as a transmission source address; and extracting the frame segment stored in the payload of the received intra-network communication frame and registering information indicating the correspondence relationship between the node indicated by the transmission source address of the intra-network communication frame and terminal indicated by the transmission source node identifier stored in the extracted frame segment.

Further, according to the present invention, there is provided a communication method applied to a communication system provided with a plurality of networks, in which a terminal is connected to a node belonging to each network as a dependent terminal to use the plurality of networks as a communication path. The method includes: storing information indicating a correspondence relationship between a terminal and a node to which the terminal is connected as a dependent terminal; generating a plurality of frame segments obtained by dividing a single frame, each of the frame segments storing a destination node identifier for identifying a destination terminal of the frame and a transmission source node identifier for identifying a transmission source terminal of the frame; generating, for each generated frame segment, an intra-network communication frame storing the frame segment in the payload after determining a transfer method or transfer destination node based on the destination node identifier stored in the frame segment and the stored correspondence relationship between the terminal indicated by the destination node identifier and node and storing a node identifier for identifying a node to which the terminal is connected as a transmission source address; distributing the intra-network communication frame to all or part of the connected nodes and transmitting; extracting the frame segment stored in the payload of the received intra-network communication frame and registering information indicating the correspondence relationship between the node indicated by the transmission source address of the intra-network communication frame and terminal indicated by the transmission source node identifier stored in the extracted frame segment; and reconstructing a frame before division from the extracted plurality of frame segments.

Further, according to the present invention, there is provided a terminal program applied to a communication system provided with a plurality of networks, in which a terminal is connected to a node belonging to each network as a dependent terminal to use the plurality of networks as a communication path. The terminal program allows a computer to execute: processing of generating a plurality of frame segments obtained by dividing a single frame, each of the frame segments storing a destination node identifier for identifying a destination terminal of the frame and a transmission source node identifier for identifying a transmission source terminal of the frame; processing of distributing the generated frame segments to all or part of the nodes to which the terminal is connected and transmitting; and processing of reconstructing a frame before division from a plurality of frame segments which are received from a node to which the terminal is connected and which are generated by the frame segment generation means provided in a different terminal from the terminal.

Further, according to the present invention, there is provided a terminal program applied to a communication system provided with a plurality of networks, in which a terminal is connected to a node belonging to each network as a dependent terminal to use the plurality of networks as a communication path. The terminal program allows a computer having a storage device for storing information indicating a correspondence relationship between a terminal and a node to which the terminal is connected as a dependent terminal to execute: processing of generating a plurality of frame segments obtained by dividing a single frame, each of the frame segments storing a destination node identifier for identifying a destination terminal of the frame and a transmission source node identifier for identifying a transmission source terminal of the frame; processing of generating, for each generated frame segment, an intra-network communication frame storing the frame segment in the payload after determining a transfer method or transfer destination node based on the destination node identifier stored in the frame segment and the correspondence relationship between the terminal indicated by the destination node identifier and node which is stored in the storage device and storing a node identifier for identifying a node to which the terminal is connected as a transmission source address; processing of distributing the generated intra-network communication frames to all or part of the nodes to which the terminal is connected and transmitting; processing of extracting the frame segment stored in the payload of the received intra-network communication frame and registering, in the storage device, information indicating the correspondence relationship between the node indicated by the transmission source address of the intra-network communication frame and terminal indicated by the transmission source node identifier stored in the extracted frame segment; and processing of reconstructing a frame before division from the extracted frame segments.

Further, according to the present invention, there is provided a node program applied to a communication system provided with a plurality of networks, in which a terminal is connected to a node belonging to each network as a dependent terminal to use the plurality of networks as a communication path. The node program allows a computer having a storage device for storing information indicating a correspondence relationship between a terminal and a node to which the terminal is connected as a dependent terminal to execute:
processing of generating, when receiving the frame segment from its dependent terminal, an intra-network communication frame storing the received frame segment in the payload after determining a transfer method or transfer destination node based on the destination node identifier stored in the frame segment and storage content stored in the correspondence relationship storage means and storing a node identifier for identifying the node as a transmission source address; and processing of extracting the frame segment stored in the payload of the received intra-network communication frame and registering, in the storage device, information indicating the correspondence relationship between the node indicated by the transmission source address of the intra-network communication frame and terminal indicated by the transmission source node identifier stored in the extracted frame segment.

### ADVANTAGES OF THE INVENTION

According to the present invention, by generating, on the terminal side, the frame segments each contains information required for the connecting network to determine a transfer method or transfer node, it is possible to achieve frame transfer operation using the existing communication system. Therefore, by combining a plurality of networks each having an arbitrary transmission amount, the transmission capacity of the entire network can be flexibly increased. Since only the terminal side needs to be provided with a plurality of ports, a highly reliable communication system can be constructed at lost cost.

Further, according to the present invention, the frame is divided into a plurality of frame segments for transmission, so that a traffic having a communication bandwidth exceeding the communication bandwidth of each network and in which a change in the order of frames are prohibited can be transferred.

### BRIEF DESCRIPTION OF THE DRAWINGS

FIG. 1 is an explanatory view showing a first embodiment of a communication system according to the present invention;

FIG. 2 is a block diagram showing a configuration example of an RPR node 100 in the first embodiment;

FIG. 3 is an explanatory view showing an example of a correspondence relationship registered in an FDB of the RPR node 100;

FIG. 4 is an explanatory view showing an example of information registered in a TDB of the RPR node 100;

FIG. 5 is an explanatory view showing an example of information stored in a MAC address management table of the RPR node 100;

FIG. 6 is an explanatory view showing an example of information stored in a port state table of the RPR node 100;

FIG. 7 is a block diagram showing a configuration example of a node 300 in the first embodiment;

FIG. 8 is an explanatory view showing an example of information stored in a port state table of the node 300;

FIG. 9 is an explanatory view showing an example of a frame format;

FIG. 10 is a flowchart showing operation performed when the RPR node has received a broadcast frame;

FIG. 11 is a block diagram showing a configuration example of an Ethernet frame reconstruction section 710;

FIG. 12 is an explanatory view showing an example of information registered in a frame segment management table of a node 320;

FIG. 13 is an explanatory view showing an example of information registered in a frame segment storage table of the node 320;

FIG. 14 is an explanatory view showing an example of information registered in a frame segment storage address management table of the node 320;

FIG. 15 is a flowchart showing operation performed in the case where a node has received a frame segment;

FIG. 16 is a flowchart showing operation performed in the case where the RPR node has received a unicast frame;

FIG. 17 is a block diagram showing a configuration example of the RPR node 100 in a second embodiment;

FIG. 18 is a block diagram showing a configuration example of the node 300 in the second embodiment;

FIG. 19 is an explanatory view showing an example of information registered in the FDB of the node 300;

FIG. 20 is an explanatory view showing an example of information registered in the MAC address management table of the node 300;

FIG. 21 is an explanatory view showing a third embodiment of the communication system according to the present invention;

FIG. 22 is a block diagram showing a configuration example of the RPR node 100 in the third embodiment;

FIG. 23 is an explanatory view showing an example of information registered in the TDB of the RPR node 100;

FIG. 24 is an explanatory view showing an example of an RPR network; and

FIG. 25 is an explanatory view showing an example in which an LAG is applied to the RPR network.

### EXPLANATION OF REFERENCE SYMBOLS

100 to 130, 200 to 230: RPR node
500-1 to 500-4: Input port
510: RPR frame generation section
520: RPR switch processing section
530: Frame segment extraction section
540-1 to 540-4: Output port
550: FDB
560: FDB management section
570: TDB
580: MAC address management table
590: Port state monitoring section
600: Port state table
610: TDB management section
300 to 330: Node
700-1 to 700-2: Input port
710: Ethernet frame reconstruction section
711: Ethernet frame reconstruction processing section:
712: Frame segment management table
713: Frame segment storage table
714: Frame segment storage address management table
720: Ethernet frame generation section
730: Frame segment generation section
740-1 to 740-2: Output port
750: Port state monitoring section
760: Port state table
810: Frame segment extraction section
820: RPR frame generation section
830: FDB management section
840: FDB
850: MAC address management table

### BEST MODE FOR CARRYING OUT THE INVENTION

### First Embodiment

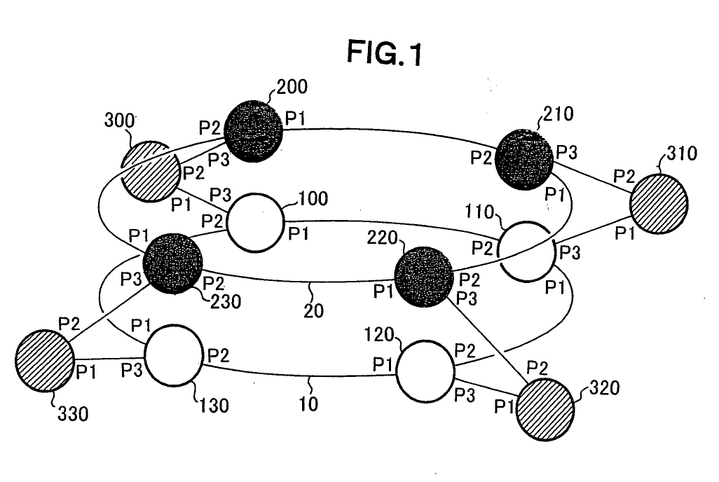

FIG. 1 is an explanatory view showing a first embodiment of a communication system according to the present invention. A communication system according to the first embodiment has an RPR network 10 including RPR nodes 100 to 130, an RPR network 20 including RPR nodes 200 to 230, and nodes 300 to 330 each of which is connected to both one RPR node belonging to the RPR network 10 and one RPR node belonging to the RPR network 20. As described above, the RPR network is a network to which the RPR has been applied.

The RPR nodes 100 to 130 and 200 to 230 not only operate according to “IEEE Std 802.17” but also perform other operations (operation for achieving an object of the present invention). In the present embodiment, a common terminal (one of the nodes 300 to 320) is located under each pair of nodes belonging to the networks 10 and 20 respectively. To locate one terminal under the RPR node means that a terminal that does not belong to a ring network to which the RPR node belongs is connected to the RPR node. The terminal located under the RPR node is hereinafter sometimes referred to merely as “dependent terminal”. The dependent terminal may belong to a ring network other than one to which the RPR node to which the terminal is connected belongs or may belong to another communication network.

In the communication system shown in FIG. 1, an RPR frame is transferred (transmitted/received) between the RPR nodes belonging to the same RPR network. Further, an Ethernet frame (concretely, Ethernet frame segment) is transferred between the RPR node and its dependent terminal. The RPR frame is a frame obtained by encapsulating a frame to be transferred between the RPR node and its dependent terminal as a payload (data main body excluding a header and the like). The header of the RPR frame includes transmission source and destination addresses and TTL (Time to Live). As the transmission source and destination addresses of the RPR frame, the address of the RPR node, address indicating broadcast transmission, or address indicating multicast transmission is stored.

Each of the RPR nodes 100 to 130 and 200 to 230 has ports P1 to P3. The ports P1 and P2 each are a port for transmitting/receiving the RPR frame, and each of the RPR nodes 100 to 130 and 200 to 230 uses the port P1 and P2 to exchange the RPR frame with its adjacent RPR nodes. Note that when a first RPR node is connected to second and third RPR nodes via a communication link, the second and third RPR nodes are referred to as adjacent RPR nodes of the first RPR node. The port P3 is a port for transmitting/receiving the Ethernet frame (concretely, Ethernet frame segment), and each of the RPR nodes 100 to 130 and 200 to 230 uses the port P3 to exchange the Ethernet frame with its dependent terminal (one of the nodes 300 to 330).

Each of the nodes 300 to 330 is a communication terminal connected to both one RPR node belonging to the RPR network 10 and one RPR node belonging to the RPR network 20 and performs communication via the RPR network.

Further, in the present embodiment, although a description is made here for a case where the nodes 300 to 330 are used as terminals for generating an Ethernet frame according to an application program, they may be nodes that can switch the Ethernet frame. In such a case, another node or another network is connected to (located under) each of the nodes 300 to 330.

Each of the nodes 300 to 330 has ports P1 and P2. The port P1 is a port for exchanging an Ethernet frame (concretely, Ethernet frame segment) with an RPR node belonging to the RPR network 10. The port P2 is a port for exchanging an Ethernet frame (concretely, Ethernet frame segment) with an RPR node belonging to the RPR network 20. The Ethernet frame segment is obtained from one Ethernet frame which is divided into a plurality of frame segments.

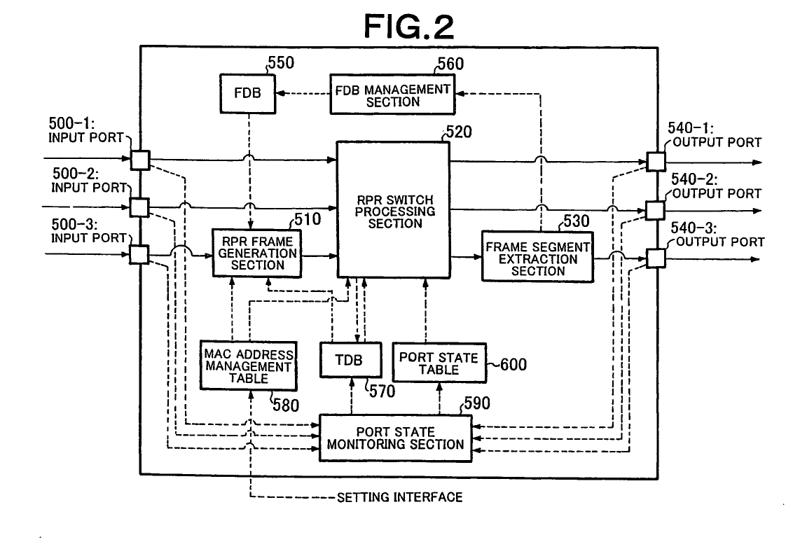

Configuration of the nodes serving as the RPR node and its dependent terminal will next be described. A configuration of the RPR node 100 will first be described. FIG. 2 is a block diagram showing a configuration example of the RPR node 100 provided in the communication system shown in FIG. 1. Although the RPR node 100 shown in FIG. 1 is taken as an example in descriptions below, the same descriptions may apply to the other RPR nodes 110 to 130 and 200 to 230.

As shown in FIG. 2, the RPR node 100 has input ports 500-1 to 500-3, an RPR frame generation section 510, an RPR switch processing section 520, a frame segment extraction section 530, output ports 540-1 to 540-3, an FDB 550, an FDB management section 560, a TDB 570, a MAC address management table 580, a port state monitoring section 590, and a port state table 600.

The input ports 500-1 to 500-3 of the RPR node 100 are receiving side ports (ports for receiving frame) in the ports P1 to P3 of the RPR node 100. The input ports 500-1 and 500-2 each are a port for receiving a frame (RPR frame) transmitted from adjacent RPR nodes. The input port 500-1 is a port for receiving an RPR frame transmitted from an adjacent RPR node located in the clockwise direction as seen from the RPR node 100, and input port 500-2 is a port for receiving an RPR frame transmitted from an adjacent RPR node located in the counterclockwise direction as seen from the RPR node 100. The input port 500-3 is a port for receiving an Ethernet frame (Ethernet frame segment) transmitted from the dependent terminal of the RPR node 100.

The output ports 540-1 to 540-3 of the RPR node 100 are transmitting side ports (ports for transmitting frame) in the ports P1 to P3 of the RPR node 100. The output ports 540-1 and 540-2 each are a port for transmitting a frame (RPR frame) to adjacent RPR nodes. The output port 540-1 is a port for transmitting an RPR frame to an adjacent RPR node located in the clockwise direction as seen from the RPR node 100, and output port 540-2 is a port for transmitting an RPR frame to an adjacent RPR node located in the counterclockwise direction as seen from the RPR node 100. The output port 540-3 is a port for transmitting an Ethernet frame (Ethernet frame segment stored in payload of RPR frame) to the dependent terminal of the RPR node 100.

More specifically, the input port 500-1 of the RPR node 100 receives an RPR frame transmitted from the output port 540-2 of the adjacent RPR node 110 located in the clockwise direction as seen from the RPR node 100. The input port 500-2 of the RPR node 100 receives an RPR frame transmitted from the output port 540-1 of the adjacent RPR node 130 located in the counterclockwise direction as seen from the RPR node 100. The input port 500-3 receives a frame segment transmitted from the output port of the node 300 which is the dependent terminal of the RPR node 100.

The output port 540-1 of the RPR node 100 transmits an RPR frame to the input port 500-2 of the adjacent RPR node 110 located in the clockwise direction as seen from the RPR node 100. The output port 540-2 of the RPR node 100 transmits an RPR frame to the input port 500-1 of the adjacent RPR node 130 located in the counterclockwise direction as seen from the RPR node 100. The output port 540-3 of the RPR node 100 transmits a frame segment stored in the payload of the RPR frame to the input port of the node 300 which is the dependent terminal of the RPR node 100.

The RPR frame generation section 510 generates an RPR frame by encapsulating a frame input via the input port 500-3.

The RPR switch processing section 520 performs processing concerning the RPR defined by “IEEE Std 802.17”. Examples of the processing performed by the RPR switch processing section 520 include transfer of the RPR frame received from the adjacent RPR nodes, management of RPR network topology information using TDP (Topology Discovery Protocol), dynamic control of communication band of the traffic on the RPR network using Fairness, and management of the RPR network using OAM (Operations, Administration, Maintenance). In the following description, details of the processing performed by the RPR switch processing section 520 will be omitted except for operation deeply involved in the operation of the node of the present invention.

The Ethernet frame extraction section 530 extracts a frame stored in the payload of the RPR frame input from the RPR switch processing section 520.

The FDB 550 is a database for managing the terminals located under the RPR nodes on the same RPR network on which the RPR node 100 is located. The FDB 550 stores the MAC address which is a node identifier of the terminal and MAC address which is a node identifier of the RPR node corresponding to the terminal in association with each other. The correspondence relationship to be stored in the FDB 550 is registered by the FDB management section to be described later. The processing of registering such a correspondence relationship in the FDB 550 in the course of transmission/reception of the frame is generally called “MAC address learning”.

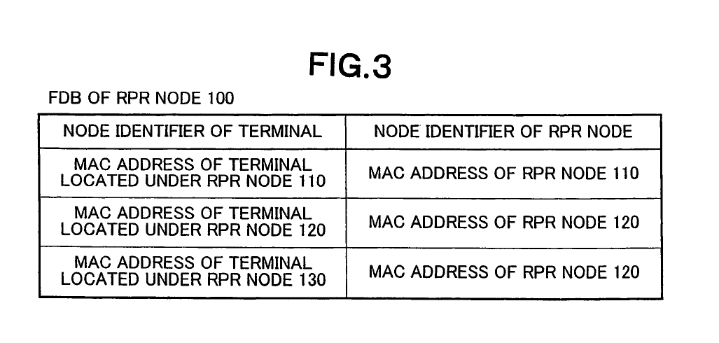

FIG. 3 is an explanatory view showing an example of the correspondence relationship registered in the FDB 550 of the RPR node 100. In the example shown in FIG. 3, the MAC address of a terminal (concretely, MAC address of node 320) located under the RPR node 120 and MAC address of the RPR node 120 are registered in association with each other. This means that in the case where the RPR node 100 has received, from its dependent terminal, an Ethernet frame (concretely, frame segment) in which the MAC address of the terminal located under the RPR node 120 is set as the destination MAC address, the RPR node 100 should set the destination MAC address of the RPR frame obtained by encapsulating the Ethernet frame to the MAC address of the RPR node 120. That is, only by knowing the destination address of the Ethernet frame, it is possible to understand to which one of RPR nodes the RPR frame is transmitted.

The FDB management section 560 updates the content registered in the FDB 550 according to a state of the local node (RPR node having the relevant FDB management section 560) or according to a request from other component provided in the local node. For example, the FDB management section 560 of the RPR node 100 registers a correspondence relationship between the MAC address of the node and MAC address of the RPR node corresponding to the node in the FDB 550 at the time of reception of a frame to thereby perform the MAC address learning. More specifically, the FDB management section 560 receives a request from the frame segment extraction section 530 and then registers the transmission source MAC address of the RPR frame received by the local node and transmission source MAC address of the frame segment stored as the payload in the RPR frame in FDB 550 in association with each other.

The TDB (Topology Database) 570 is a database for managing information concerning the RPR network to which the local node (RPR node having the relevant TDB 570) belongs. The TDB 570 stores information indicating a state of the topology of the RPR network to which the local node belongs and failure occurrence state. For example, the TDB 570 stores information indicating a failure state of the inter-RPR node link in the respective RPR nodes belonging to the RPR network to which the local node belongs or the number of hops lying from the local node to each of the RPR nodes. The information concerning the RPR network to be stored in the TDB 570 are managed (registered) by the RPR switch processing section 520 operating according to TDP (Topology Discovery protocol).

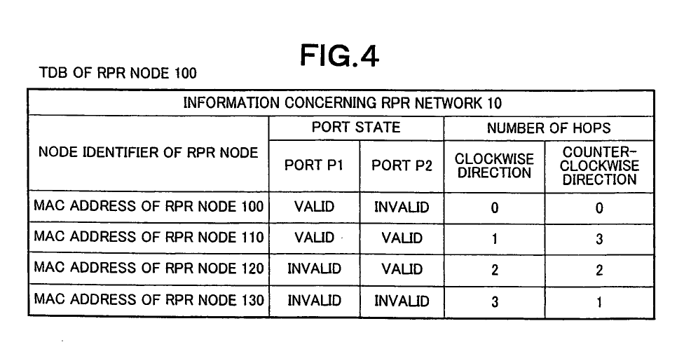

FIG. 4 is an explanatory view showing an example of information registered in the TDB 570 of the RPR node 100. In the example of FIG. 4, information indicating states of the ports P1 and P2 (ports for connecting to adjacent RPR nodes) of each of the RPR nodes belonging to the same RPR network (RPR network 10) on which the RPR node 100 is located and the number of hops lying in both the clockwise and counterclockwise directions as seen from the local node are registered in association with the node identifier (MAC address) of the RPR node. That is, information registered in the TDB 570 indicates the connection order of the respective RPR nodes belonging to the RPR network 10 and valid/invalid of the connection ports P1 and P2 of each RPR node. The valid indicates a state where the port is available and invalid indicates a state where the port is not available.

The example of TDB 570 shown in FIG. 4 indicates, for example, the RPR node 110 is connected to in the clockwise direction to the RPR node 120 and is connected in the counterclockwise direction to the RPR node 100. Further, the TDB 570 indicates, for example, that the port state of the port P1 (port for transfer in the clockwise direction) of the RPR node 130 is invalid, and port state of the port P2 (port for transfer in the counterclockwise direction) of the RPR node 130 is also invalid, which means that the RPR node 130 cannot transmit/receive the RPR frame via both the ports P1 and P2. From this information, it is possible to know that the RPR node 130 has failed for some reasons.

The port state of each RPR node is registered in the following manner. In order to manage the topology of the RPR network, each RPR node broadcast-transmits a TP frame (Topology and Protection frame) storing the states of ports (ports P1 and P2) for exchanging the RPR frame with adjacent RPR nodes at constant intervals. The RPR switch processing section 520 refers to the TP frame transmitted from each RPR node to update the states of the ports P1 and P2 of the transmission source RPR node registered in the TDB 570. The states of the ports P1 and P2 of the local node are updated by the port state monitoring section 590. That is, the port state monitoring section 590 monitors the states of the ports P1 and P2 of the local node and, based on the monitoring result, updates the states of the ports P1 and P2 of the local node registered in the TDB 570.

In the example of FIG. 4, only the information indicating valid/invalid of the port state of each RPR node and the number of hops are shown for the shake of simplicity. However, in the TDB defined by “IEEE Std 802.17” various information concerning the RPR node constituting the RPR network are managed. Actually, such various information are registered in the TDB 570 shown in FIG. 4.

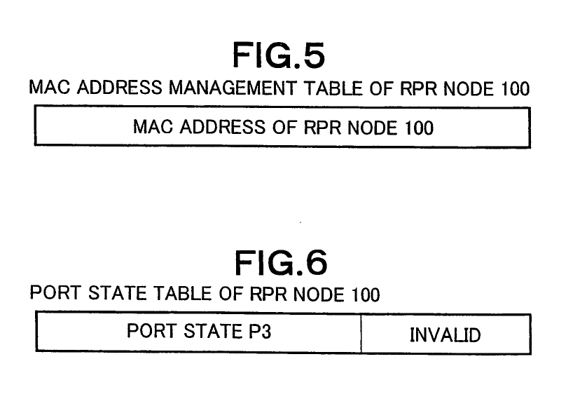

The MAC address management table 580 is a table for managing the MAC address which is uniquely assigned, in the form of a node identifier of the local node (RPR node having the relevant MAC address management table 580), to the local node. FIG. 5 is an explanatory view showing an example of information stored in the MAC address management table 580 of the RPR node 100. As shown in FIG. 5, the MAC address management table 580 of the RPR node 100 includes the MAC address of the local node (RPR node 100). The MAC address is previously registered in the MAC address management table 580 by an administrator of the communication system using a setting interface. The MAC address management table 580 is stored in a storage device such as a memory provided in the RPR node.

The MAC address registered in the MAC address management table 580 is referred to by other components of the RPR node. At least, the RPR frame generation section 510, RPR switch processing section 520 and frame segment extraction section 530 refer to the MAC address registered in the MAC address management table 580.

The port state monitoring section 590 monitors the states of the input ports 500-1 to 500-3 and output ports 540-1 to 540-3 of the local node (the RPR node having the relevant port state monitoring section 590) and updates information concerning the port state of the local node according to the monitoring result. For example, in the case where the input port 500-1 is in a receivable state and the output port 540-1 is in a transmittable state, the port state monitoring section 590 registers “valid” in the TDB 570 of the local node as the state of the port P1 and, otherwise, registers “invalid”. Further, in the case where the input port 500-2 is in a receivable state and the output port 540-2 is in a transmittable state, the port state monitoring section 590 registers “valid” in the TDB 570 of the local node as the state of the port P2 and, otherwise, registers “invalid”. Further, in the case where the input port 500-3 is in a receivable state and the output port 540-3 is in a transmittable state, the port state monitoring section 590 registers “valid” in the port state table 600 to be described later and, otherwise, registers “invalid”.

The port state table 600 is a table for managing information indicating the state of the port P3 (port connecting to a dependent terminal) of the local node (inter-link connection node having the relevant port state table 600). FIG. 6 is an explanatory view showing an example of a port state registered in the port state table 600 of the RPR node 100. As shown in FIG. 6, the port state table 600 of the RPR node includes information indicating the state of the port P3 of the local node. The port state table 600 is stored in a storage device such a memory provided in the RPR node.

The port state table shown in FIG. 6 shows that the port state of the port P3 of the RPR node 100 is invalid, which means that the RPR node 100 cannot transmit/receive an Ethernet frame via the port P3. From this information, it is possible to know that a failure has occurred in the link connecting the RPR node 100 and its dependent terminal (node 300).

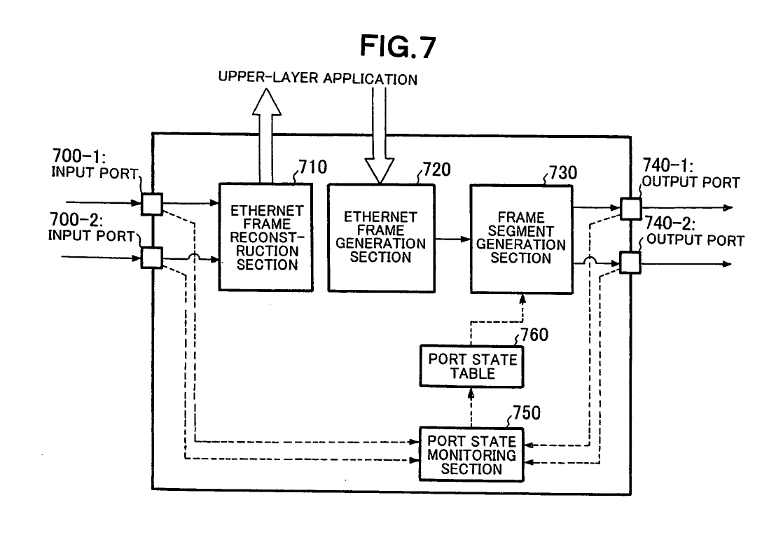

A configuration of the node serving as the dependent terminal of the RPR node will next be described. FIG. 7 is a block diagram showing a configuration example of the node 300 provided in the communication system shown in FIG. 1. Although the node 300 shown in FIG. 1 is taken as an example in descriptions below, the same descriptions may apply to the other nodes 310 to 330.

As shown in FIG. 7, the node 300 has input ports 700-1 and 700-2, an Ethernet frame reconstruction section 710, an Ethernet frame generation section 720, a frame segment generation section 730, output ports 740-1 and 740-2, a port state monitoring section 750 and a port state table 760.

The input ports 700-1 and 700-2 of the node 300 are receiving side ports (ports for receiving frame) in the ports P1 and P2 of the node 300 shown in FIG. 1. Each of the input ports P1 and P2 is are a port for receiving a frame transmitted from the connecting RPR node. The input port 700-1 is a port for receiving an Ethernet frame (frame segment stored in payload of RPR frame) transmitted from an RPR node belonging to the RPR network 10. The input port 700-2 is a port for receiving an Ethernet frame (frame segment stored in payload of RPR frame) transmitted from an RPR node belonging to the RPR network 20.

The output ports 740-1 and 740-2 of the node 300 are transmitting side ports (ports for transmitting frame) in the ports P1 and P2 of the node 300 shown in FIG. 1. The input ports 700-1 and 700-2 each are a port for transmitting a frame to the connecting RPR node. The output port 740-1 is a port for transmitting an Ethernet frame (frame segment) to an RPR node belonging to the RPR network 10. The output port 740-2 is a port for transmitting an Ethernet frame (frame segment) to an RPR node belonging to the RPR network 20.

More specifically, the input port 700-1 of the node 300 receives an Ethernet frame (frame segment) transmitted from the output port 540-3 of the RPR node 100 belonging to the RPR network 10. The input port 700-2 of the node 300 receives an Ethernet frame (frame segment) transmitted from the output port 540-3 of the RPR node 200 belonging to the RPR network 20. The output port 740-1 of the node 300 transmits an Ethernet frame (frame segment) to the output port 540-3 of the RPR node 100 belonging to the RPR network 10. The output port 740-1 of the node 300 transmits an Ethernet frame (frame segment) to the output port 540-3 of the RPR node 200 belonging to the RPR network 20.

The Ethernet frame reconstruction section 710 generates, from a frame segment received by the local node (node having the relevant Ethernet frame reconstruction section 710), a single Ethernet frame that has not been divided. That is, the Ethernet frame reconstruction section 710 generates an Ethernet frame having the same content as the original Ethernet frame (Ethernet frame before division) based on information indicating a dividing configuration included in a received frame segment. A concrete configuration example of the Ethernet frame reconstruction section 710 and a method of reconstructing an Ethernet frame will be described later.

The Ethernet frame generation section 720 generates an Ethernet frame according to a request from an upper-layer application. The Ethernet frame generation section 720 outputs a generated Ethernet frame to the frame segment generation section 730.

The frame segment generation section 730 divides the Ethernet frame output from the Ethernet frame generation section 72 according to a predetermined condition to generate a plurality of Ethernet frames (frame segments). Further, the frame segment generation section 730 outputs the generated frame segments to output ports 740-1 and 740-2 according to a predetermined condition.

The port state monitoring section 750 monitors the states of the input ports 700-1, 700-2 and output ports 740-1, 740-2 and updates information (e.g., information indicating the execution status of the ports) concerning the port state registered in the port state table 760 to be described later according to the monitored state. For example, in the case where the input port 700-1 is in a receivable state and the output port 740-1 is in a transmittable state, the port state monitoring section 750 registers “valid” in the port state table 760 as the state of the port P1 and, otherwise, registers “invalid”. Further, in the case where the input port 700-2 is in a receivable state and the output port 740-2 is in a transmittable state, the port state monitoring section 750 registers “valid” in the port state table 760 as the state of the port P2 and, otherwise, registers “invalid”.

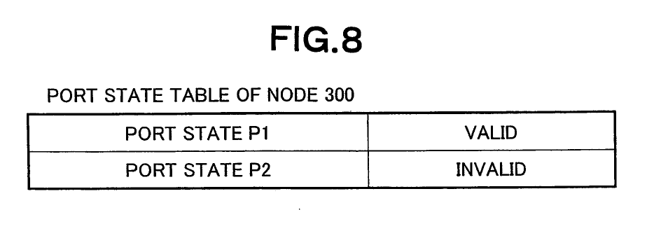

The port state table 760 is a table for managing information indicating the states of the ports P1 and P2 (ports for exchanging Ethernet frame with connecting RPR node) of the local node (node having the relevant port state table 760). FIG. 8 is an explanatory view showing an example of a port state registered in the port state table 760 of the node 300. As shown in FIG. 8, the port state table 760 of the node 300 include's information indicating the states of the ports P1 and P2 of the local node. The port state table 760 is stored in a storage device such a memory provided in the inter-link connection node.

The port state table shown in FIG. 8 shows that the port state of the port P1 of the node 300 is valid and port state of the port P2 is invalid, which means that the node 300 can transmit/receive an Ethernet frame via the port P1 but cannot transmit/receive an Ethernet frame via the port P2. From this information, it is possible to know that a failure has occurred in the link connecting the RPR node 200 and node 300.

A frame transfer operation in the present embodiment will next be described. First, a frame transfer operation performed in normal operation time will be described. Concretely, a description is made here for a case where an Ethernet frame is exchanged between the node 300 and node 320 in normal operation time.

It should be noted that it is assumed that the MAC address learning has not been made in all the RPR nodes that receive the frame segment at this time point. That is, it is assumed that, at the time point when the frame transfer operation is carried out from the node 300 to node 320, no information has been registered in the FDBs 550 of all the RPR nodes belonging to the RPR networks 10 and 20.

The Ethernet frame generation section 720 of the node 300 generates an Ethernet frame destined to the node 320 according to a request from an upper-layer application. The Ethernet frame generation section 720 then transmits the generated Ethernet frame to the frame segment generation section 730.

The frame segment generation section 730 of the node 300 divides the received Ethernet frame into a plurality of frame segments according to a predetermined method.

A dividing method of the Ethernet frame will be described below. Various dividing methods can be employed depending on the operation policy of the communication system. Hereinafter, some examples of the methods suitably applied to the present invention will be described.

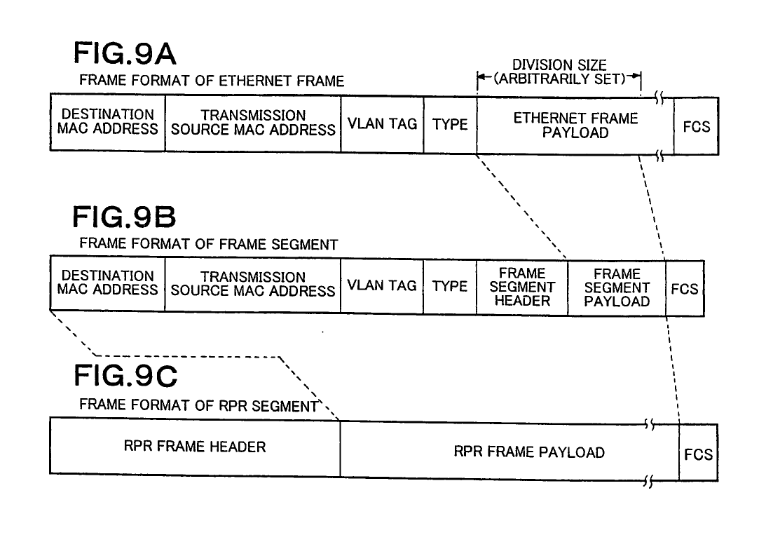

First, a frame format employed in the present embodiment will be described. FIG. 9 is an explanatory view showing an Ethernet frame format, a frame segment format, and an RPR frame format, which are frame formats employed in the present embodiment.

FIG. 9 (a) is an explanatory view showing the frame format of the Ethernet frame. As shown in FIG. 9 (a), the Ethernet frame includes destination MAC address, transmission source MAC address, VLAN (Virtual LAN) tag, type, payload (Ethernet frame payload), and FCS (Frame Check Sequence). Although the Ethernet frame with VLAN tag is taken as an example in FIG. 9 (a), the Ethernet frame that does not include the VLAN tag may be employed.

In destination MAC address, the MAC address of a node which is the transmission destination of the relevant Ethernet frame. In transmission source MAC address, the MAC address of a node which is the transmission source of the relevant Ethernet frame is stored. In VLAN tag, information indicating the VLAN of the relevant Ethernet frame, such as a VLAN identifier indicating to which VLAN the relevant Ethernet frame belongs or information indicating the priority are stored. In type, a protocol identifier indicating the upper protocol of the relevant Ethernet frame is stored. In Ethernet frame payload, communication data as the Ethernet frame is stored. In FCS, information for detecting an error in the Ethernet frame which is generated from the relevant Ethernet frame is stored.

FIG. 9 (b) is an explanatory view showing the frame format of the frame segment in the present embodiment. As shown in FIG. 9 (b), the frame segment in the present embodiment includes destination MAC address, transmission source MAC address, VLAN tag, type, frame segment header, payload (frame segment payload), and FCS. That is, the configuration of the frame format is the same as that of the frame format of the Ethernet frame except that the frame segment header has been inserted before the payload.

The values stored in the Ethernet frame are stored, without modification, in the same header information (destination MAC address, transmission source address, and the like) as those of the Ethernet frame. However, as to FCS, information for detecting an error in the frame segment which is generated from the relevant frame segment is recalculated and stored in FCS.

In frame segment header, information needed for reconstructing the frame segment into the original Ethernet frame is stored. Concretely, information including a frame identifier (e.g., sequence number) for identifying from which Ethernet frame the relevant frame segment is derived and division configuration information indicating how the Ethernet frame has been divided (e.g., information indicating the number of frame segments and the order thereof) are stored in the frame segment header as the header information.

A sufficient bit-field (number of bits) needs to be prepared for the frame identifier even if a plurality of Ethernet frames are divided respectively and are transferred to the RPR network so that frame segments obtained as a result of the division are not mixed up together. The value of the number of divisions becomes a value of the number of frames corresponding to the frame segments generated from a single Ethernet frame, so that it can assume any natural number value. However, a caution needs to be given to the following point. That is, in the case where the value of the number of divisions are set to a value larger than the number of the RPR nodes to which the local node is connected, distribution destinations overlap as the value becomes larger, with the result that overhead caused due to the generation of the frame segments decreases the increasing efficiency of the transmission capacity.

In frame segment payload, any one of data obtained by dividing communication data stored in the payload of the original Ethernet frame into a plurality of data segments are stored as communication data as the frame segment.

FIG. 9 (c) is an explanatory view showing the frame format of the RPR frame. The RPR frame is a frame obtained by encapsulating an Ethernet frame (frame segment) transferred from a dependent terminal as the payload so that an Ethernet frame destined to dependent terminals of respective RPR nodes belonging to the RPR network can be transferred between the respective RPR nodes. The RPR frame roughly includes RPR frame header, payload, and FCS. In RPR frame header, transmission source and destination addresses and TTL (Time to Live) are stored. As the transmission source and destination addresses of the RPR frame, the MAC address of the RPR node, address indicating broadcast transmission, or address indicating multicast transmission is stored.

Note that it is not always necessary that the frame format of the frame segment includes the same header information as those of the Ethernet frame so as to maintain the same configuration. The configuration of the frame format of the frame segment is not limited to the format shown in FIG. 9 (b) but the frame format of the frame segment may have any configuration as long as the RPR node that has received the frame segment can recognize the destination node and generate the RPR frame, and the frame format includes information required for each RPR node to perform the MAC address learning based on the generated RPR frame in the course of transfer of the RPR frame. In the case of the Ethernet frame, the frame format thereof may have any configuration as long as it includes at least destination MAC address and transmission source MAC address. This example in which the frame segment includes the same header information as those of the Ethernet frame is effective for a case where it is necessary to make the RPR node unconscious of the fact that the received frame is a frame segment.

A method of dividing the Ethernet frame includes, e.g., a method that divides the payload of the Ethernet frame in units of a previously determined fixed frame length to generate frame segments each having a fixed frame size. In this case, since the size of the payload of the Ethernet frame is not fixed, the number of divisions of the payload of the Ethernet does not become constant. In this case, there is a possibility that the frame segments are biased toward one of the RPR networks 10 and 20 to decrease the increasing efficient of the transmission capacity. Therefore, there is a need to take some measure such as employing Round-Robin method as an algorism according to which the terminal distributes the frame segments to the respective RPR nodes.

Further, when the division size of the payload of the Ethernet frame is set to a small value, the number of divisions of the payload of the Ethernet frame correspondingly increases, which may result in a decrease in the increasing efficiency of the transmission capacity. On the other hand, when the division size of the payload of the Ethernet frame is set to a large value, the size of the payload of the Ethernet frame cannot be divided by the payload division size, which may result in loss of a communication band. Therefore, it is necessary to carefully determine the payload division size according to the execution status of the communication system.

As another dividing method, there is known a method that divides the payload of the Ethernet frame in units of a previously determined number of divisions. In this case, by setting the number of divisions of the payload of the Ethernet frame equal to the number of RPR nodes to which a node that transmits the Ethernet frame is connected, it is possible to maximize the increasing efficiency of the transmission capacity.

In this case, however, the size of each frame segment differs for each Ethernet frame, so that frame segment generation processing may become complicated. In the above dividing method, any unit, such as bit or byte may be used to divide the Ethernet frame.

In the case where the size of the payload of the Ethernet frame cannot be divided by a determined number of divisions, reserved data is inserted into the payload to correct the size of the payload to one that can be divided. The reserved data to be inserted may be a previously determined fixed value (e.g., data in which all bits are 0) or may include the payload size of the original Ethernet frame. The payload size of the original Ethernet frame may be included in the frame segment header. At the time of reconstructing the original Ethernet frame from a plurality of frame segments, the reserved data that has been inserted can be deleted by referring to the payload size of the Ethernet frame.

The frame segment generation section 730 of the node 300 divides the Ethernet frame according to a previously determined dividing method to generate a plurality of frame segments. In the present embodiment, a description is made for a case where the payload of the Ethernet frame is divided by the number corresponding to the RPR nodes to which a node that transmits the Ethernet frame is connected and where the division is made in units of a byte.

The frame segment generation section 730 recognizes the number of RPR nodes to which the local node is connected as the number of divisions. The frame segment generation section 730 then generates the frame segments by the number corresponding to the determined number of divisions. Subsequently, the frame segment generation section 730 stores sequence number, number of divisions of the payload of the Ethernet frame, and serial number of the frame segment in the frame segment headers of the respective frame segments.

Further, the frame segment generation section 730 stores, in the header information of the respective frame segments (destination MAC address, transmission source MAC address, VLAN tag) except for FCS of the same information as the header information of the original Ethernet frame. Here, the frame segment generation section 730 inserts reserved data into the payload of the Ethernet frame, if needed, so that the payload of the Ethernet frame can be divided by the number of divisions. After that, the frame segment generation section 730 divides the payload of the Ethernet frame by a determined number of divisions and stores the resultant payloads obtained by the division in the payloads of the respective frame segments. Finally, the frame segment generation section 730 calculates information for detecting a frame error and stores the calculated information in the FCS of the respective frame segments.

After generating the frame segments, the frame segment generation section 730 distributes the frame segments to a plurality of connecting RPR nodes. In this case, the number of the frame segments corresponds to the number of connecting RPR nodes, so that the frame segment generation section 730 transmits one frame segment to the respective RPR nodes. More specifically, the frame segment generation section 730 generates two frame segments from the Ethernet frame destined to the node 320 which has been generated by the Ethernet frame generation section 320 and then transmits the frame segments respectively to the two connecting RPR nodes via the output ports 740-1 and 740-2 of the node 300. For example, the frame segment generation section 730 may transmit a first frame segment to the RPR node 100 via the output port 740-1 and transmit a second frame segment to the RPR node 200 via the output port 740-2.

Operation from the time when the node 300 transmits the frame segments to the RPR nodes 100 and 200 until the time when the frame segments are transferred to the node 320 will next be described.

When the frame segment is transmitted from the node 300 via the output port 740-1, the RPR node 100 receives the frame segment via the input port 500-3. The frame segment received via the input port 500-3 is passed to the RPR frame generation section 510. That is, the RPR frame generation section 510 of the RPR node 100 receives the frame segment from the node 300 via the input port 500-3.

The RPR frame generation section 510 of the RPR node 100 uses the destination MAC address of the frame segment as a search key to search the FDB 550 to thereby acquire the MAC address of the RPR node corresponding to a terminal indicated by the destination MAC address of the frame segment. That is, the RPR frame generation section 510 finds and loads the MAC address of the RPR node associated with the destination MAC address (MAC address of the node 320) of the frame segment. When the acquisition has successfully been completed, the RPR frame generation section 510 encapsulates the frame segment to generate an RPR frame in Which the MAC address of the loaded RPR node is set as the destination MAC address.

In this case, no information has been registered in the FDB 550, so that the RPR frame generation section 510 fails to acquire the MAC address of the RPR node associated with the destination MAC address of the Ethernet frame.

When having failed to acquire the MAC address of the RPR node, the RPR frame generation section 510 generates an RPR frame in which: a broadcast MAC address is stored as the destination MAC address; the MAC address of the local node (RPR node 100) is stored as the transmission source MAC address; frame segment is stored in the payload; and information for detecting an RPR frame error is stored in the FCS. The RPR frame generation section 510 can confirm the MAC address of the local node by referring to the MAC address management table 580. The RPR frame generation section 510 transmits the generated RPR frame to the RPR switch processing section 520.

After the processing of determining the MAC address of the RPR node from the information of the frame segment, the header information (destination MAC address, transmission source MAC address, VLAN type, and type) of the original Ethernet frame stored in an overlapped manner in the respective frame segments only needs to be stored in any one of frame segments, except for the information (transmission source MAC address) required for the MAC address learning of the RPR node.

Therefore, in order to efficiently increase the transmission capacity of the RPR networks 10 and 20, one of the RPR node 100 and RPR node 200 may delete the above header information at the time when generating the RPR frame from the frame segment. Alternatively, the RPR node 100 and RPR node 200 may delete only predetermined information from the header information so as not to delete the same data. For example, header information that one RPR node can delete may previously be stored in the one RPR node in association with the node identifier thereof. Then, each PRP node may delete the header information stored in association with the node identifier of the local node so as to delete the header information in a non-overlapped manner.

When the RPR nodes connected to the node that transmits the Ethernet frame generate the RPR frames having the same frame size in the case where they delete a part of the header information respectively in a non-overlapped manner, the traffic amounts in the RPR networks 10 and 20 become the same. Therefore, dynamic control functions of the respective RPR nodes for the communication band of the traffic in the RPR networks 10 and 20 function in the same level. This reduces a difference in the arrival time of the frame segments generated from the same Ethernet frame to the destination node, resulting in a reduction of the delay time.

In the case where the destination MAC address of the RPR frame is the broadcast MAC address, that is, in the case where the RPR frame is a broadcast frame, the RPR switch processing section 520 of the RPR node 100 broadcast-transmits the RPR frame.

More specifically, the RPR switch processing section 520 copies the RPR frame, sets a maximum natural number that does not exceed ½ of a value obtained by subtracting 1 from the number of the RPR nodes belonging to the RPR network 10 in the TTL field of each of the respective RPR frames, and transmits one RPR frame in the clockwise direction and the other RPR frame in the counterclockwise direction. Such a broadcast method is called Bidirectional Broadcast. The RPR switch processing section 520 can confirm the number of the RPR nodes belonging to the RPR network 10 by referring to the TDB 570. For example, in the example of FIG. 4, the number of entries registered in the TDB 570 of the RPR node 100 corresponds to the number of the RPR nodes belonging to the RPR network 10.

There is available another broadcast method called Unidirectional Broadcast. In the Unidirectional Broadcast, the RPR switch processing section 520 does not copy the RPR frame but stores a value obtained by subtracting 1 from the number of the RPR nodes belonging to the RPR network 10 in the TTL field of the RPR frame and transmits the RPR frame in the clockwise direction or counterclockwise direction.

Hereinafter, a description is made for a case where all the RPR nodes belonging to the RPR networks 10 and 20 use the Bidirectional Broadcast.

The RPR switch processing section 520 stores “2” in the TTL field of one RPR frame and transmits the RPR frame via the output port 540-1. Further, the RPR switch processing section 520 stores “1” in the TTL field of the other RPR frame and transmits the RPR frame via the output port 540-2.

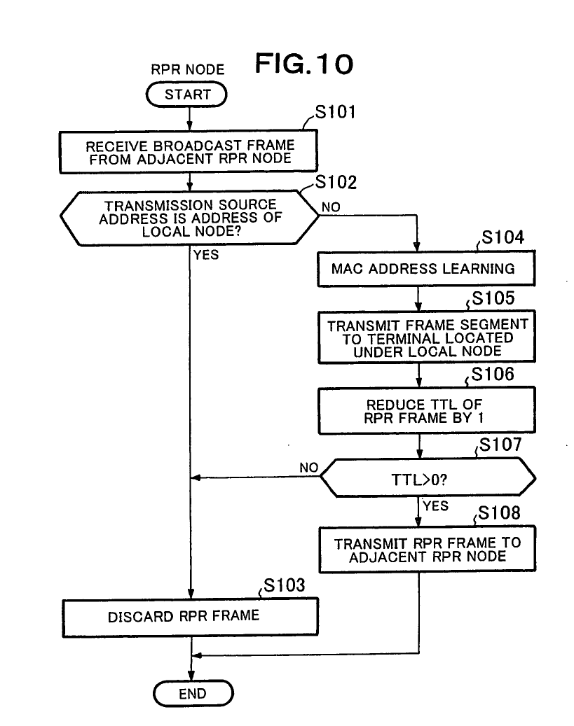

The RPR frame transmitted via the output port 540-1 of the RPR node 100 is transferred to the RPR node 110. FIG. 10 is a flowchart showing operation performed when the RPR node (RPR node 130) has received the broadcast RPR frame. Basically, the RPR node only necessary to operate according to “IEEE Std 802.17”.

The RPR node 110 receives the RPR frame transmitted from the RPR node 100 via the input port 500-2 (step S101). The RPR frame received via the input port 500-2 is passed to the RPR switch processing section 520. That is, the RPR switch processing section 520 of the RPR node 110 receives the RPR frame from the RPR node 100 via the input port 500-2.

When the transmission source MAC address of the received RPR frame is the MAC address of the local node (Yes in step S102), the RPR switch processing section 520 discards the RPR frame in order to prevent occurrence of a broadcast storm in loop configuration (step S103). In this example, the transmission source MAC address of the RPR frame is the MAC address of the RPR node 100, so that the RPR switch processing section 520 of the RPR node 110 does not discard the RPR frame. The RPR switch processing section 520 can confirm the MAC address of the local node by referring to the MAC address management table 580.

Subsequently, in the case where the transmission source MAC address of the RPR frame is not the MAC address of the local node and where the destination MAC address of the RPR frame is a broadcast MAC address, the RPR switch processing section 520 passes the received RPR frame to the frame segment extraction section 530. At this time, the RPR switch processing section 520 may copy the RPR frame so that it can transmit the received RPR frame to an adjacent RPR node.

The frame segment extraction section 530 of the RPR node 110 decapsulates the RPR frame passed from the RPR switch processing section 520 to extract the frame segment stored in the payload. Then, the frame segment extraction section 530 transmits the extracted frame segment via the output port 540-3 of the local node to the dependent terminal of the local node (step S105). Further, at the time of extracting the frame segment, the frame segment extraction section 530 requires the FDB management section 560 to perform the MAC address learning based on the received RPR frame.

The FDB management section 560 of the RPR node 110 performs the MAC address learning based on the received RPR frame according to the request from the Ethernet frame extraction section 530 (step S104). The FDB management section 560 registers a correspondence relationship between the transmission source MAC address (MAC address of the node 300) of the frame segment stored in the payload of the received RPR frame and the transmission source MAC address (MAC address of the RPR node 100) of the RPR frame in the FDB 550. That is, the FDB management section 560 performs the MAC address learning concerning the node 300.

As control processing of transmitting the received RPR frame to an adjacent RPR node, the RPR switch processing section 520 subtracts “1” from the value of the TTL stored in the received RPR frame (step S106). When the resultant TTL value is larger than 0, the RPR switch processing section 520 transmits the RPR frame to the next RPR node (Yes in step S107, step S108). More specifically, the RPR switch processing section 520 transmits, in the same direction as the transfer direction at the reception time, the RPR frame storing the TTL after subtraction to the RPR node 120 via the output port 540-1 of the local node. When the TTL value after subtraction is 0, the RPR switch processing section 520 discards the RPR frame (No in step S107, S103).

In this example, the value of the TTL stored in the RPR frame that the RPR node 110 receives is a value (=2) of the TTL set in the RPR node 100, so that even if the RPR switch processing section 520 subtracts “1” from the value of the TTL, the resultant TTL value does not become 0. Therefore, the RPR node 110 transfers the RPR frame storing the TTL after subtraction to the adjacent RPR node 120.

Afterward, each of the RPR nodes 120 and 130 belonging to the RPR network 10 performs the same operation as the RPR node 110 to transmit the frame segment to the dependent terminal thereof while transferring the RPR frame to the next RPR node within a time period specified by the TTL. As a result, one of the two RPR frames broadcast-transmitted from the RPR node 100 is sequentially transmitted to the RPR node 110 and RPR node 120, whereby the frame segment stored in the RPR frame is transmitted to the dependent terminals (node 310, node 320) of the RPR nodes 110 and 120, respectively, and the other one of the two RPR frames broadcast-transmitted from the RPR node 100 is transferred to the RPR node 130, whereby the frame segment stored in the RPR frame is transmitted to the dependent terminal (node 330) of the RPR node 130. The RPR frames that have reached the RPR nodes 120 and 130 are not transferred to adjacent RPR nodes but are discarded at this time point because the TTL stored in each RPR frame becomes 0.

The RPR node 200 belonging to the RPR network 20 performs the same operation as the RPR node 100 to generate the RPR frame encapsulating the frame segment transmitted from the node 300 and broadcast-transmits the resultant RPR frame to the RPR nodes 210 and 230. Each of the RPR nodes 210 to 230 belonging to the RPR network 20 performs the same operation as the RPR node 110 to transmit the frame segment to the dependent terminal thereof while transferring the RPR frame to the next RPR node within a time period specified by the TTL. As a result, one of the two RPR frames broadcast-transmitted from the RPR node 200 is sequentially transmitted to the RPR node 210 and RPR node 220, whereby the frame segment stored in the RPR frame is transmitted to the dependent terminals (node 310, node 320) of the RPR nodes 210 and 220, respectively, and the other one of the two RPR frames broadcast transmitted from the RPR node 200 is transferred to the RPR node 230, whereby the frame segment stored in the RPR frame is transmitted to the dependent terminal (node 330) of the RPR node 230.

In the manner as described above, the two frame segment that the node 300 has distributed to the RPR nodes 100 and 200 are transferred to the node 320.

Operation performed in the case where the node (node 320) has received the frame segments from the connecting RPR nodes will next be described. When receiving the frame segments from the RPR nodes 100 and 200 via the input ports 700-1 and 700-2, the node 320 passes the received frame segments to the Ethernet frame reconstruction section 710.

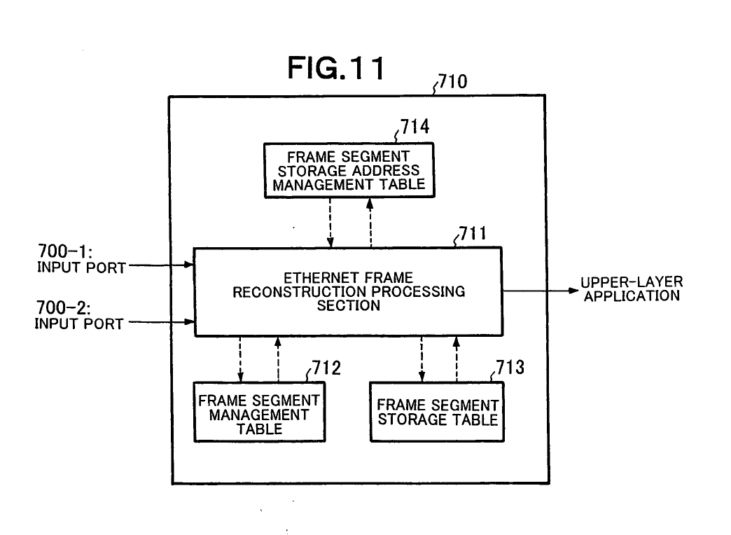

A method of reconstructing the original Ethernet frame from the frame segments performed by the Ethernet frame reconstruction section 710 will be described below. Although the operation of the Ethernet frame reconstruction section 710 of the node 320 is taken as an example in descriptions below, the same descriptions may apply to the operations of the other nodes (nodes 310 to 330). FIG. 11 is a block diagram showing a configuration example of the Ethernet frame reconstruction section 710. As shown in FIG. 11, the Ethernet frame reconstruction section 710 has an Ethernet frame reconstruction processing section 711, a frame segment management table 712, a frame segment storage table 713, and a frame segment storage address management table 714.

The Ethernet frame reconstruction processing section 711 controls the entire operation of the Ethernet frame reconstruction section 710. More specifically, the Ethernet frame reconstruction processing section 711 performs control for reconstruction of the original Ethernet frame from the frame segments received from the connecting RPR nodes.

The frame segment management table 712 is a table for managing the storage content of the frame segment storage table 713 that stores the frame segments and includes information concerning the frame segments registered in the frame segment storage table 713. That is, the frame segment management table 712 associates information indicating which frame segment that the local node is currently receiving and information indicating the location at which the received frame segment is stored with information for identifying the original Ethernet frame from which the frame segment has been generated. The frame segment management table 712 is registered by the Ethernet frame reconstruction processing section 711.

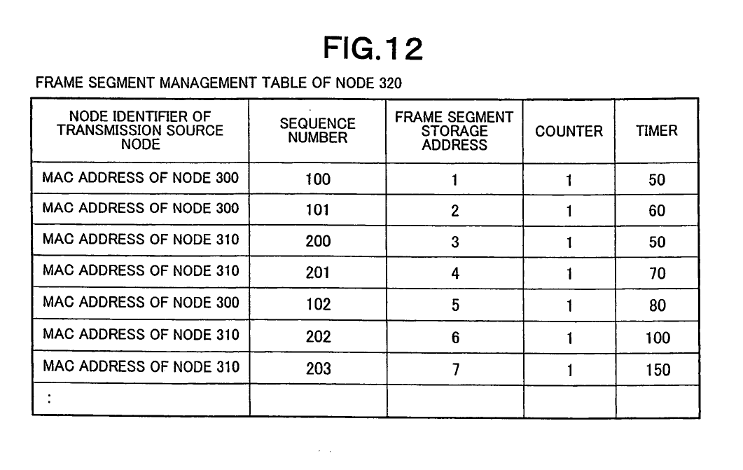

FIG. 12 is an explanatory view showing an example of information registered in the frame segment management table 712 of the node 320. As shown in FIG. 12, the frame segment management table 712 includes, e.g., transmission source MAC address of received frame segment, sequence number of frame segment, storage address of frame segment, counter, and timer.

The transmission source MAC address of frame segment is a node identifier for identifying the node that has transmitted the Ethernet frame from which the frame segment has been generated. The sequence number of frame segment is a frame identifier for indicating the Ethernet frame from which the frame segment has been generated. The storage address of frame segment is information indicating the registration locations of the frame segments that have been generated from the same Ethernet frame in the frame segment storage table 713 provided in the local node. The counter is information indicating, for each Ethernet frame from which the frame segments have been generated, the number of the frame segments to be received from this time. The counter value may be the number of the frame segments that have not been received or may be represented by both the number of the frame segments that have been received and the number of divisions. The point is that it is only necessary to be able to detect, from the counter value, that all the frame segments that have been generated from the same Ethernet frame have been received.

The timer indicates a time period during which a first frame segment can wait for the subsequent frame segment. That is, the timer is set to a predetermined value at the time when the first frame segment of all the frame segments that have been generated from the same Ethernet frame is received. Afterward, the value of the timer is decremented every certain time. At the time point when the timer value becomes 0, the first frame segment managed in the entry including the relevant timer is discarded.

The table shown in FIG. 12 shows that one frame segment that has been generated from the Ethernet frame with a sequence number 100 transmitted from the node 300 is registered at a storage address 1 of the frame segment storage table 713. The table further shows that when the residual one frame segment is not received before “50/timer unit” has elapsed, the relevant Ethernet frame is not reconstructed but the frame segment that has been received is discarded.

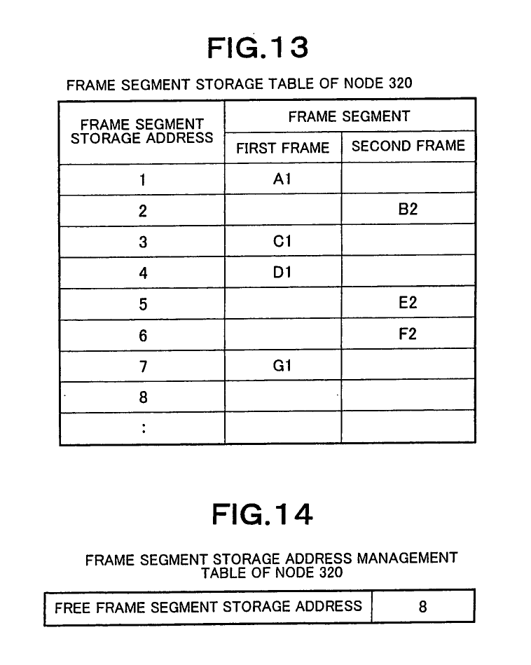

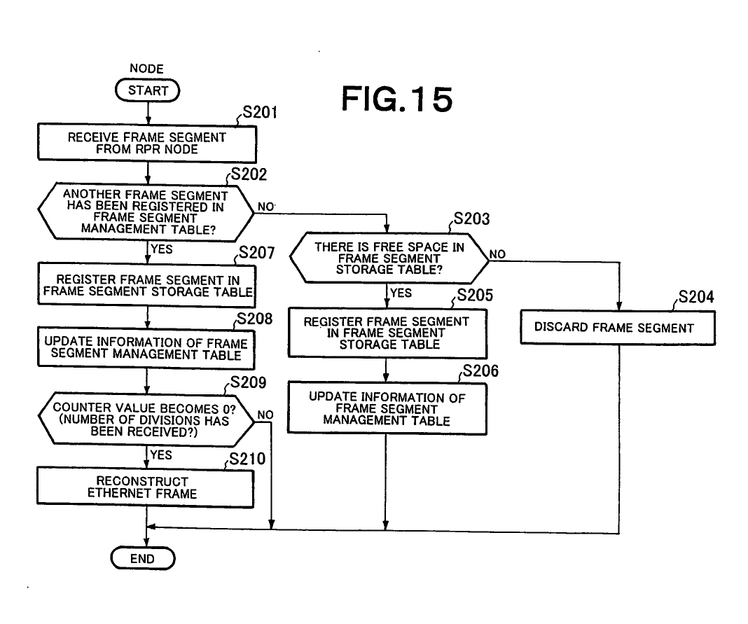

The frame segment storage table 713 is a table for retaining the frame segment received by the local node. FIG. 13 is an explanatory view showing an example of information registered in the frame segment storage table 713 of the node 320. The frame segment storage table 713 may have a configuration as shown in FIG. 13 in which the frame segments that have been generated from the same Ethernet frame are registered in pairs with the frame segment storage address used as the index. That is, in the entry indexed with a single frame segment storage address, the frame segments that have been generated from the same Ethernet frame are stored.

In FIG. 13, the storage area of the frame segments is divided into two sections: one for storing the first frame segment and the other is for storing the second frame segment. In the case where the Ethernet frame is divided into three or more, a storage area large enough to store all the frame segments is ensured. The Table shown in FIG. 13 shows that a frame segment A1 which is the first frame segment is stored in the frame segment area associated with the storage address 1. By referring to the table of FIG. 12, it is possible to know that the storage address 1 is a storage area in which the frame segments that have been generated from the Ethernet frame with a sequence number 1 transmitted from the node 300 are stored.

The frame segment storage address management table 714 is a table for managing storage addresses at which the frame segment has not yet been registered in the frame segment storage table 713. FIG. 14 is an explanatory view showing an example of information registered in the frame segment storage address management table 714 of the node 320. As shown in FIG. 14, the frame segment storage address management table 714 stores information indicating storage addresses at which the frame segment has not yet been registered in the frame segment storage table 713, in other words, information indicating storage address at which the frame segment is to be registered next. Here, a configuration may be adopted in which, an invalid value (e.g., NULL value) is registered in the frame segment storage address management table 714 to thereby represent that there is no free space for storing frame segments (frame segments that are not managed by the frame segment storage address management table 714) that have been generated from a new Ethernet frame in the frame segment storage table 713.

The frame segment management table 712, frame segment storage table 713, and frame segment storage address management table 714 are stored in a storage device such as a memory provided in the node.

When receiving the frame segment via the input port 700-1 or input port 700-2 (step S201), the Ethernet frame reconstruction processing section 711 of the node 320 checks whether information concerning the Ethernet frame from which the received frame segment has been generated is registered in the frame segment management table 712 (step S202). The Ethernet frame reconstruction processing section 711 uses the transmission source MAC address and sequence number as search keys to search the frame segment management table 712 to acquire the frame segment storage address.

When the Ethernet frame reconstruction processing section 711 has failed to acquire the frame segment storage address (No in step S202), it turns out that no frame segment that has been generated from the same Ethernet frame as that from which the received frame segment has been generated is not registered in the frame segment management table 712. In such a case, the Ethernet frame reconstruction processing section 711 refers to the frame segment storage address management table 714 to check whether there is a free space in the frame segment storage table 713 (step S203). In the case where an invalid value has been set in the storage address of the frame segment storage address management table 714, the Ethernet frame reconstruction processing section 711 discards the received frame segment (step S204) and does not perform reconstruction processing. In the case where the value that has been set in the storage address of the frame segment storage address management table 714 is not an invalid value, the Ethernet frame reconstruction processing section 711 registers the received frame segment in the frame segment storage table 713 with the storage address registered in the frame segment storage address management table 714 used as an index (step S205).

The Ethernet frame reconstruction processing section 711 then updates information of the frame segment management table 712 (step S206). The Ethernet frame reconstruction processing section 711 adds one entry to the frame segment management table 712 and stores, in the added entry, information concerning the Ethernet frame indicated by the frame segment registered in the frame segment storage table 713, the number of frame segments that have not been received which is indicated by division configuration information, and maximum value of the wait time for frame segment. Concretely, the Ethernet frame reconstruction processing section 711 registers, in the added entry, the transmission source MAC address of the registered frame segment, sequence number, value obtained by subtracting 1 from the number of divisions, and maximum value of the wait time for the next frame segment.

The Ethernet frame reconstruction processing section 711 also updates information of the frame segment storage address management table 714. The Ethernet frame reconstruction processing section 711 registers, in the frame segment storage address management table 714, the storage address of one of the entries of the frame segment management table 712 in which the frame segment has not been registered. If there is no entry in the frame segment management table 712 in which the frame segment has not been registered, the Ethernet frame reconstruction processing section 711 registers an invalid value (e.g., NULL value) in the frame segment storage address management table 714.

Afterward, the Ethernet frame reconstruction processing section 711 of the node 320 decrements, by a certain value, the timer value of the entry registered in the frame segment management table 712 every certain time. At the time point when the timer value becomes 0 or less, the Ethernet frame reconstruction processing section 711 deletes an entry including the relevant timer from the frame segment management table 712 as well as an entry in the frame segment storage table 713 indicated by the storage address of the frame segment in the relevant entry.

In the case whether information concerning the Ethernet frame from which the received frame segment has been generated is registered in the frame segment management table 712, that is, in the case where the Ethernet frame reconstruction processing section 711 has successfully acquired the frame segment storage address from the frame segment management table 712 (Yes in step S202), the Ethernet frame reconstruction processing section 711 registers the received frame segment in the frame segment storage table 713 with the acquired storage address used as an index (step S207).

Then, the Ethernet frame reconstruction processing section 711 updates the information of the frame segment management table 712 (step S208). With respect to the frame segment management table 712, the Ethernet frame reconstruction processing section 711 subtracts 1 from the counter value of the entry in which the acquired storage address is managed.

When the counter value becomes 0 as a result of subtraction, the Ethernet frame reconstruction processing section 711 recognizes that it has received all the frame segments that have been generated from the same Ethernet frame and then reconstructs the original Ethernet frame from the frame segments.

More specifically, the Ethernet frame reconstruction processing section 711 integrates data stored in the payloads of the respective frame segments according to information stored in the frame segment header included in the frame segments and stores the integrated data in the payload of the Ethernet frame. Further, the Ethernet frame reconstruction processing section 711 registers header information of the Ethernet frame based on the header information of the frame segments.

The header information of the Ethernet frame are registered in all the frame segments in an overlapped manner in the present embodiment. Thus, it is only necessary that the header information of one of the frame segments is directly stored in the header information of the Ethernet frame. However, in the case where the header information of one of the frame segments has been deleted by the RPR node in order to realize efficient increase in the transmission capacity of the RPR network, the header information of the Ethernet frame is set based on the header information of the frame segment whose header information has not been deleted.

Finally, the Ethernet frame reconstruction processing section 711 calculates information for detecting a frame error and stores the calculated information in the FCS.

After the Ethernet frame reconstruction processing section 711 has reconstructed the Ethernet frame, the node 320 performs the same operation as the conventional one performed at the Ethernet frame reception time. For example, the node 320 recognizes the reconstructed Ethernet frame is destined to the local node by referring to the destination MAC address of the Ethernet frame and outputs the Ethernet frame to an upper-layer application.

The reconstruction processing of the Ethernet frame described above is performed in the same manner in any other nodes that receive the frame segments from the RPR node. In this example, the nodes except for the node 320 determine that the reconstructed Ethernet frame is not destined to the local node and discards the Ethernet frame.

As described above, the terminal (node) connected to a plurality of RPR networks generates frame segments each added with information required for the connecting RPR nodes to perform the MAC address learning and information required for the transfer destination terminal to reconstruct the Ethernet frame and distributes the frame segments, whereby it is possible to flexibly increase the transmission capacity using the existing communication system. For example, if the transmission capacity of the RPR network 10 becomes insufficient, it is only necessary to construct another RPR network 20. The reason that it is possible to realize a configuration in which the terminal is connected to a plurality of RPR network is that the terminals and RPR nodes control frame transfer operation such that a loop configuration is not formed.

Further, each of the respective terminals manages the received frame segments using the frame segment management table 712 to thereby manage the frame segments transmitted from different transmission sources using a single storage table, with the result that the price of the terminal can be reduced.

Next, following the above description, operation performed in the case where the Ethernet frame is returned from the node 320 to node 300 will be described. In the following, it is assumed that all the RPR nodes belonging to the RPR networks 10 and 20 have completed the MAC address learning through the frame transfer operation from the node 300 to node 320. That is, it is assumed that the correspondence relationship between the MAC address of the node 300 and MAC address of the RPR node 100 is registered in the FDB 550 of all the RPR nodes belonging to the RPR network 10. Further, it is assumed that the correspondence relationship between the MAC address of the node 300 and MAC address of the RPR node 200 is registered in the FDB 550 of all the RPR nodes belonging to the RPR network 20.

The Ethernet frame generation section 720 of the node 320 generates an Ethernet frame destined to the node 300 according to a request from an upper-layer application. The Ethernet frame generation section 720 then passes the generated Ethernet frame to the frame segment generation section 730.

The frame segment generation section 730 of the node 320 divides the Ethernet frame generated by the Ethernet frame generation section 720 to generate frame segments and transmits the generated frame segments to connecting RPR nodes (RPR nodes 120 and 220) in the same manner as the node 300.

Operation from the time when the node 320 has transmitted the frame segments to the RPR nodes 120 and 220 until the time when the frame segments are transferred to the node 300 will next be described. When the frame segments are transmitted from the node 320, each of the RPR nodes 120 and 220 receives the frame segment.

The RPR node 120 receives one frame segment transmitted from the node 320 via the input port 500-3 and passes the received frame segment to the RPR frame generation section 510. The RPR frame generation section 510 of the RPR node 120 uses the destination MAC address of the frame segment as a search key to search the FDB 550 of the RPR node 120 to acquire the MAC address of an RPR node corresponding to the terminal specified by the destination MAC address of the frame segment. That is, the RPR frame generation section 510 acquires the MAC address of the RPR node associated with the destination MAC address (MAC address of the node 300) of the frame segment from the FDB 550 by the search processing and loads the acquired MAC address.

In this case, the RPR frame generation section 510 successfully acquires the MAC address of the RPR node (RPR node 100). When successfully acquiring the MAC address, the RPR frame generation section 510 generates an RPR frame in which: the acquired MAC address is stored as the destination MAC address; the MAC address of the local node is stored as the transmission source MAC address; and frame segment received from the dependent terminal of the local node is stored in the payload. The RPR frame generation section 510 transmits the generated RPR frame to the RPR switch processing section 520. When failing to acquire the MAC address, the RPR frame generation section 510 sets a broadcast MAC address as the destination MAC address as in the case of the RPR node 100.

When the destination MAC address of the RPR frame is a node-specific MAC address, that is, when the RPR frame is a unicast frame, the RPR switch processing section 520 of the RPR node 120 unicast-transmits the RPR frame destined to the RPR node 100 via the output port 540-1 or output port 540-2. At this time, the number of hops lying between the output port 540-1 or output port 540-2 and destination RPR node is stored in the TTL field of the RPR frame. The RPR frame can confirm the number of hops lying from the local node to the destination node by referring to the TDB 570.

A description is made here for a case where the RPR switch processing section 520 of the RPR node 120 transmits the RPR frame from the output port 540-1 via the RPR node 130. In this case, the number of hops (=2) lying along the clockwise communication path between the RPR node 120 and RPR node 100 is stored in the TTL field. When the RPR node 120 transmits the RPR frame via the output port 540-1, the RPR node 130 receives the RPR frame.

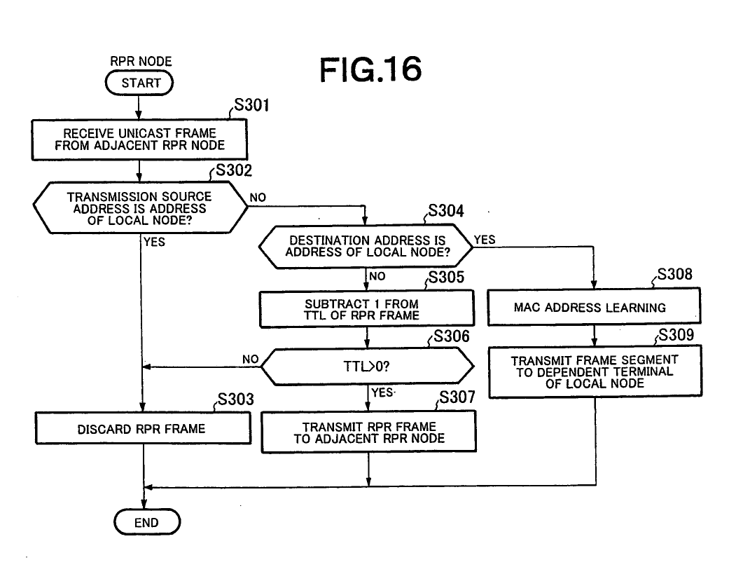

FIG. 16 is a flowchart showing operation performed in the case where the RPR node (RPR node 130 in this example) has received a unicast frame. The RPR node basically operates according to “IEEE Std 802.17”.

The RPR node 130 receives the RPR frame transmitted from the output port 540-1 of the RPR node 120 via the input port 500-2 (step S301). The RPR frame received by the RPR node 130 via the input port 500-2 is passed to the RPR switch processing section 520.

When the transmission source MAC address of the received RPR frame is the MAC address of the local node (Yes in step S302), the RPR switch processing section 520 discards the RPR frame in order to prevent occurrence of a broadcast storm in loop configuration (step S303). In this example, the transmission source MAC address of the RPR frame is the MAC address of the RPR node 120, so that the RPR switch processing section 520 of the RPR node 130 does not discard the RPR frame.

Subsequently, in the case where the transmission source MAC address of the RPR frame is not the MAC address of the local node and where the destination MAC address of the RPR frame is a node-specific (unicast) MAC address, the RPR switch processing section 520 determines whether the destination MAC address of the RPR frame is the MAC address of the local node (step S304).

In the case where the destination MAC address of the received RPR frame is not the MAC address of the local node (No in step S301), the RPR switch processing section 520 performs control operation for transferring the received RPR frame to an adjacent RPR node. The control operation for transferring the received RPR frame to an adjacent RPR node performed here is the same as that performed in the RPR node 110 described above. That is, in the case where the destination MAC address of the received RPR frame does not coincide with the MAC address of the local node, the RPR switch processing section 520 subtracts 1 from the value of the TTL stored in the RPR frame (step S305) and, when the TTL value after the subtraction is larger than 0, transmits the RPR frame to the next RPR node (Yes in step S306, S307). When the TTL value after the subtraction becomes 0, the RPR switch processing section 520 discards the RPR frame (No in step S306, S303).

In the case where the destination MAC address of the received RPR frame coincides with the MAC address of the local node (Yes in step S304), the RPR switch processing section 520 performs control operation for transmitting the frame segment stored in the payload of the received RPR frame to the dependent terminal. The control operation for transmitting the received RPR frame to the dependent terminal performed here is the same as that performed in the RPR node 110 described above. That is, in the case where the destination MAC address of the received RPR frame coincides with the MAC address of the local node, the RPR switch processing section 520 passes the RPR frame to the frame segment extraction section 530. The frame segment extraction section 530 extracts the frame segment from the RPR frame and transmits the extracted frame segment to the dependent terminal via the output port 540-3 (step S309). Further, at this time, the FDB management section 560 registers the correspondence relationship between the node 320 and MAC address of the RPR node 120 in the FDB 550 for the MAC address learning (step S308).

In this example, the destination MAC address of the unicast frame transmitted from the RPR node 120 is not the MAC address of the RPR node 130, so that the RPR node 130 does not transmit the Ethernet frame to the dependent terminal but transfers the RPR frame to the next RPR node (RPR node 100) after subtracting 1 from the TTL value.

Afterward, each of the RPR nodes 100 and 110 belonging to the RPR network 10 performs the same operation as the RPR node 130 described above to transfer the RPR frame to the next RPR node within a time period specified by the TTL. As a result, the RPR frame destined to the RPR node 100 that has been unicast-transmitted from the RPR node 120 is sequentially transferred to the RPR node 130 and RPR node 100, whereby the frame segment (e.g., the first frame segment) stored in the RPR frame is transmitted to the dependent terminal (node 300) of the RPR node 100 by the RPR node 100.

The RPR node 220 belonging to the RPR network 20 performs the same operation as the RPR node 120 to generate the RPR frame encapsulating the frame segment transmitted from the node 320 and unicast-transmits the resultant RPR frame to the RPR nodes 200. Each of the RPR nodes 230 and 210 belonging to the RPR network 20 performs the same operation as the RPR nodes 130 and 100 to transfer the RPR frame to the next RPR node within a time period specified by the TTL. As a result, the RPR frame destined to the RPR node 200 that has been unicast transmitted from the RPR node 220 is sequentially transferred to the RPR node 230 and RPR node 200, whereby the frame segment (e.g., the second frame segment) stored in the RPR frame is transmitted to the dependent terminal (node 300) of the RPR node 200 by the RPR node 200.

In the manner as described above, the two frame segment that the node 320 has distributed to the RPR nodes 120 and 220 are transferred to the node 300.

When receiving the frame segments from the RPR nodes 100 and 200 via the input ports 700-1 and 700-2, the node 300 reconstructs the Ethernet frame in the same manner as the node 320.

The frame transfer operation in the normal operation time has been described taking communication between the node 300 and node 320 as an example. In the present embodiment, it is only necessary that a plurality of ports are provided in each of the dependent terminals of the RPR nodes, so that a highly reliable communication system can be constructed at low cost.

Next, a frame transfer operation performed in the case where a failure such as link disconnection or malfunction of the RPR node occurs in one or both of the RPR networks 10 and 20 will be described.

In the present embodiment, even if an abnormality occurs in the RPR network 10 and/or RPR network 20, in the case where communication is possible (connectivity is maintained) between all the RPR nodes belonging to the RPR network 10 and where communication is possible (connectivity is maintained) between all the RPR nodes belonging to the RPR network 20, frames can be distributed to the RPR networks 10 and 20 as in the case of the frame transfer operation in the normal operation time. This is because that the frame transfer is made such that the frames bypass the disconnected portion according to failure recovery operation of the RPR, whereby communication between the RPR nodes belonging to the RPR network can be maintained.

For example, assume that a failure occurs in a given RPR node. In this case, if the frame segment has been divided and distributed to the RPR node in which a failure has occurred, it is impossible to continue communication between a dependent terminal of the RPR node in which a failure has occurred and terminals of the other RPR nodes. However, if each terminal (node) does not distribute the frame segment to the RPR node in which a failure has occurred, communication can be maintained although the transmission capacity of the entire RPR network is decreased.

The dependent terminal of the RPR node in which a failure has occurred can directly detect disconnection of a link to the connecting RPR node by referring to the port state table 760 provided in the local node. The port state monitoring section 590 detects that the ports P1 and P2 (input ports 500-1 and 500-2, or output ports 540-1 and 540-2) become invalid (state where the ports are disabled) and sets the port state of the relevant ports registered in the port state table 600 to “invalid”.

Further, when a given RPR node detects that a failure has occurred in another RPR node belonging to the same RPR network with result that connectivity is lost in the RPR network, the RPR node detecting the failure intentionally brings down (stops) the port (port P3) for connecting to its dependent terminal in order to allow the dependent terminal to detect the abnormality.

After the above operation is performed, the terminal refers to the port state table 760 at the time when transmitting the Ethernet frame to thereby recognize the number of ports whose port state is valid as the number of divisions and restricts the distribution destination to ports whose state is valid.

Further, the RPR node may notify its dependent terminal of the content of the TDB 570 provided in the local node, whereby the terminal can recognize a failure state of the connecting RPR network and can set the number of divisions of the Ethernet frame and distribution destination RPR network according to the failure state.

Further, in the case where a link between the RPR node and its dependent terminal is disconnected, it is impossible to maintain communication between the terminal and terminals of other RPR nodes. In this case, however, it is only necessary that when the RPR node detects occurrence of an abnormality in the port (port P3) to which its dependent terminal is connected, it intentionally brings down (stops) a link between the local node and both side adjacent RPR nodes. With this operation, the adjacent RPR nodes detect the abnormality and intentionally bring down the link to their dependent terminals, thereby maintaining communication although the transmission capacity of the entire RPR network is decreased.

As described above, according to the present invention, even if the Ethernet frame is divided, it is possible to increase the transmission capacity of the entire RPR network without contradiction with the frame transfer operation performed in the RPR network. Therefore, it is possible to use a network like the RPR network that can perform the MAC address learning as a plurality of communication paths for inter-node communication. This prevents the number of settings for the path from becoming tremendous, thereby reducing the burden on a network administrator.

In the present embodiment, each of the nodes 300 to 330 generates the Ethernet frame by itself. However, when each of the nodes 300 to 330 is configured to be a node that can switch the Ethernet frame, it includes a switch port for receiving the Ethernet frame in place of the Ethernet frame generation section 720.

### Second Embodiment

A second embodiment of the present invention will be described below with reference to the accompanying drawings. A configuration of a communication system according to the present invention is the same as that of the first embodiment shown in FIG. 1 except for a point that a frame that the RPR node exchanges with its dependent terminal via the port P3 is not the frame segment but the RPR frame.

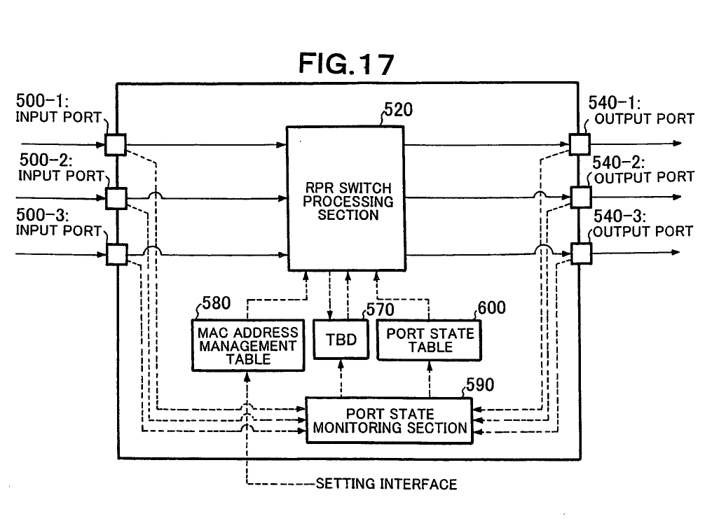

Configurations of the RPR node and a node serving as the dependent terminal of the RPR node will next be described. FIG. 17 is a block diagram showing a configuration example of the RPR node 100 in the second embodiment. Although the RPR node 100 is taken as an example in descriptions below, the same descriptions may apply to the other RPR nodes 110 to 130 and 200 to 230.

As shown in FIG. 17, the RPR node 100 according to the present embodiment differs from the RPR node of the first embodiment shown in FIG. 2 in that it does not include the RPR frame generation section 510, frame segment extraction section 530, FDB 550, and FDB management section 560.

In the first embodiment, the input port 500-3 receives the frame segment and passes the received frame segment to the RPR frame generation section 510. However, in the present embodiment, the input port 500-3 receives the RPR frame and passes the received RPR frame to the RPR switch processing section 520. In the first embodiment, the RPR switch processing section 520 passes the RPR frame to the frame segment extraction section 530 for transfer control to its dependent terminal. However, in the present embodiment, the RPR switch processing section 520 directly transmits the RPR frame to its dependent terminal via the output port 540-3. Configurations of other components are the same as those of the first embodiment.

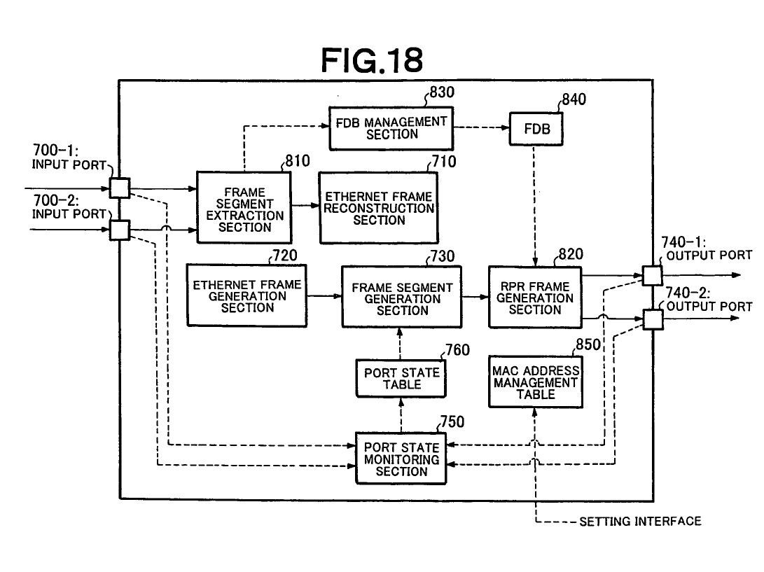

FIG. 18 is a block diagram showing a configuration example of the node 300 in the second embodiment. Although the node 300 is taken as an example in descriptions below, the same descriptions may apply to the other nodes 310 to 330.

As shown in FIG. 18, the node 300 according to the present embodiment differs from the node of the first embodiment shown in FIG. 7 in that it further includes a frame segment extraction section 810, an RPR frame generation section 820, an FDB management section 830, an FDB 840, and a MAC address management table 850.

In the first embodiment, the frame segment generation section 730 transmits the frame segments to the connecting RPR nodes. However, in the present embodiment, the frame segment generation section 730 passes the frame segments to the RPR frame generation section 820.

The RPR frame generation section 820 generates the RPR frames from the frame segments passed from the frame segment generation section 730. Then, the RPR frame generation section 820 distributes the generated RPR frames to the connecting RPR nodes (RPR nodes 100 and 200) via the output ports 740-1 and 740-2.

To the frame segment extraction section 810, the RPR frames transmitted from the connecting RPR nodes are input via the input ports 700-1 and 700-2. The frame segment extraction section 810 extracts the frame segments stored in the received RPR frames and passes the extracted frame segments to the Ethernet frame reconstruction section 710.

The FDB management section 830 registers, in the FDB 840 to be described later, a correspondence relationship between the node identifier (MAC address of the RPR node) of the transmission source node of the RPR frame and node identifiers (MAC addresses of the nodes) of the transmission source nodes of the frame segments according to a request from the frame segment extraction section 810.

The FDB 840 is a database for managing the terminals located under the RPR nodes to which the local node is connected. The FDB 550 stores the node identifiers (MAC addresses) of the terminals and node identifier (MAC address) of the RPR node corresponding to the terminals in association with each other. The correspondence relationship to be stored in the FDB 840 is registered by the FDB management section 830.

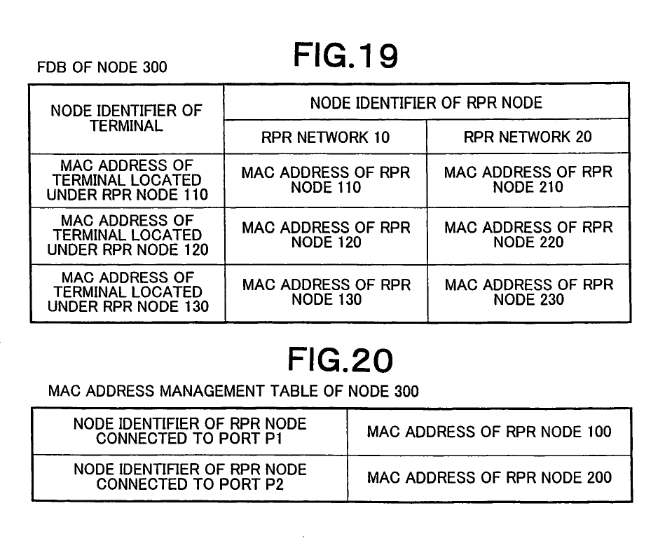

FIG. 19 is an explanatory view showing an example of information registered in the FDB 840 of the node 300. As shown in FIG. 19, the FDB 840 stores the MAC address of the RPR node belonging to the RPR network 10 and MAC address of the RPR node belonging to the RPR network 20 in association with the MAC address of their one dependent terminal (node).

In the example shown in FIG. 19, the MAC address of the RPR node 120 and MAC address of the RPR node 220 are registered in association with the MAC address of a terminal (node 320) located under the RPR node 120. This means that the node 320 is located under both the RPR nodes 120 and 220.

The MAC address management table 850 is a table for managing the MAC address of the RPR node under which the local node is located. FIG. 20 is an explanatory view showing an example of information registered in the MAC address management table 850 of the node 300. As shown in FIG. 20, the MAC address management table 850 of the node 300 includes the MAC address of the RPR node connected to the port P1 of the local node (node 300) and MAC address of the RPR node connected to the port P2 thereof. The MAC address is previously registered in the MAC address management table 850 by an administrator of the communication system using a setting interface. The MAC address management table 850 is stored in a storage device such as a memory provided in the RPR node. Configurations of other components are the same as those of the first embodiment.

A frame transfer operation in the present embodiment will next be described. The frame transfer operation according to the present embodiment differs from that according to the first embodiment in the following two points. The first point is that after generating frame segments, the terminal (node) generates RPR frames and transfers the generated RPR frames to the RPR nodes. The second point is that the terminal receives, not the frame segments stored in the payloads of the RPR frames, but the RPR frames themselves, followed by extraction of the frame segments from the RPR frames for reconstruction of the original Ethernet frame. The operation other than the above is the same as that in the first embodiment, and descriptions thereof will be omitted.

First, operation in which the RPR frame generation section 820 of the node 300 generates the RPR frames will be described. The RPR frame generation section 820 of the node 300 receives, from the Ethernet frame generation section 720, frame segments generated by dividing a single Ethernet frame. The RPR frame generation section 820 uses the destination MAC address of the received frame segments as a search key to search the FDB 840 to acquire the MAC address of the RPR node under which a node specified by the destination MAC address of the frame segments is located.

When failing to acquire the MAC address of the RPR node due to absence of information in the FDB 840 of the node 300, the RPR frame generation section 820 generates RPR frames destined to a broadcast address by the number corresponding to the number of frame segments. More specifically, the RPR frame generation section 820 generates RPR frames in each of which; a broadcast MAC address is stored as the destination MAC address of the RPR frame; the MAC address of the RPR node under which the local node (node 300) is located is stored as the transmission source MAC address; and frame segment is stored in the payload.

As the transmission source MAC address of the RPR frame, the MAC address of the RPR node connected to the port that transmits the RPR frame is stored. In the payload of the RPR frame, any one of the frame segments is stored in a non-overlapped manner. The RPR frame generation section 820 can confirm the MAC address of the connecting RPR node by referring to the MAC address management table 850.

The RPR frame generation section 820 then transmits the RPR frames to the RPR nodes corresponding to the MAC addresses stored as the transmission source MAC addresses of the respective RPR frames via the output ports 740-1 and 740-2.

When the node 300 transmits the RPR frames each encapsulating the frame segment via the output ports 740-1 and 740-2, the connecting RPR nodes 100 and 200 receive the RPR frames, respectively.

Each of the RPR nodes 100 and 200 receives the RPR frame via the input ports 500-3 and passes the received RPR frame to the RPR switch processing section 520. The RPR switch processing section 520 performs transfer control to an adjacent RPR node and transmission control to the dependent terminal of the local node. In this embodiment, as the transmission control, the RPR switch processing section 520 transmits the received RPR frame to the dependent terminal without modification. Therefore, the RPR frames are transferred to the destination node (e.g., node 320) of the original Ethernet frame via the RPR node 100 and RPR node 200, respectively.

Operation in which the frame segment extraction section 810 of the node 320 extracts the frame segment from the received RPR frame will be described.

When receiving the unicast transmitted RPR frame destined to the local node and broadcast-transmitted RPR frame, the RPR node transmits the received RPR frames to its dependent terminals. The node 320 receives the RPR frames from the RPR node connected thereto via the input ports 700-1 and 700-2. The RPR frames received via the input ports 700-1 and 700-2 of the node 320 are then passed to the frame segment extraction section 810.

The frame segment extraction section 810 of the node 320 decapsulates the RPR frame passed via the input port 700-1 or input port 700-2 to extract the frame segment stored in the payload. The frame segment extraction section 810 passes the extracted frame segment to the Ethernet frame reconstruction section 710. Further, at the time when extracting the frame segment, the frame segment extraction section 810 requires the FDB management section 830 to perform the MAC address learning based on the received RPR frame.

The FDB management section 830 of the node 320 performs the MAC address learning based on the received RPR frame according to the request from the frame segment extraction section 810. The FDB management section 830 registers a correspondence relationship between the transmission source MAC address (MAC address of the node 300) of the frame segment stored in the payload of the received RPR frame and the transmission source MAC address (MAC address of the RPR node 100 or RPR node 200) of the RPR frame in the FDB 840 to thereby associates the node 300 with the RPR node 100.

Afterward, the Ethernet frame reconstruction section 710 of the node 320 reconstructs the original Ethernet frame from the frame segment in the same manner as in the first embodiment.

As described above, according to the present embodiment, even when the RPR frame generation section 510, frame segment extraction section 530, FDB 550, and FDB management section 560, which are provided on the RPR node side in the first embodiment, are provided on the terminal side, it is possible to obtain the same effect as that in the first embodiment. Further, the configuration of the RPR node becomes simplified to make it possible to reduce the price of the RPR node, resulting in a reduction of cost involved in increasing the transmission capacity of the RPR node.

### Third Embodiment

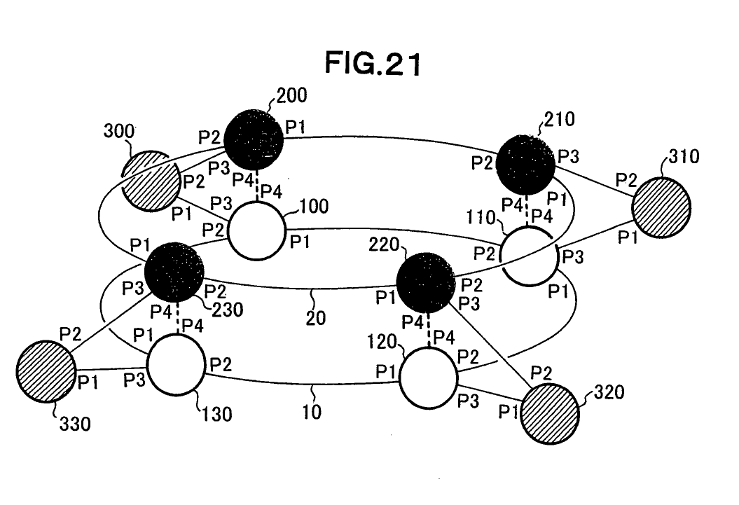

A third embodiment of the present invention will be described below with reference to the accompanying drawings. FIG. 21 is an explanatory view showing a configuration example of a communication system according to the present embodiment. The communication system shown in FIG. 21 differs from the communication system according to the first embodiment shown in FIG. 1 in that RPR nodes under which the same terminal is located are connected by a communication link. As shown in FIG. 21, each of the RPR nodes 100 to 130 and 200 to 230 has a port P4 in addition to the ports P1 to P3. The port P4 is a port for exchanging topology information between RPR nodes belonging to different RPR networks.

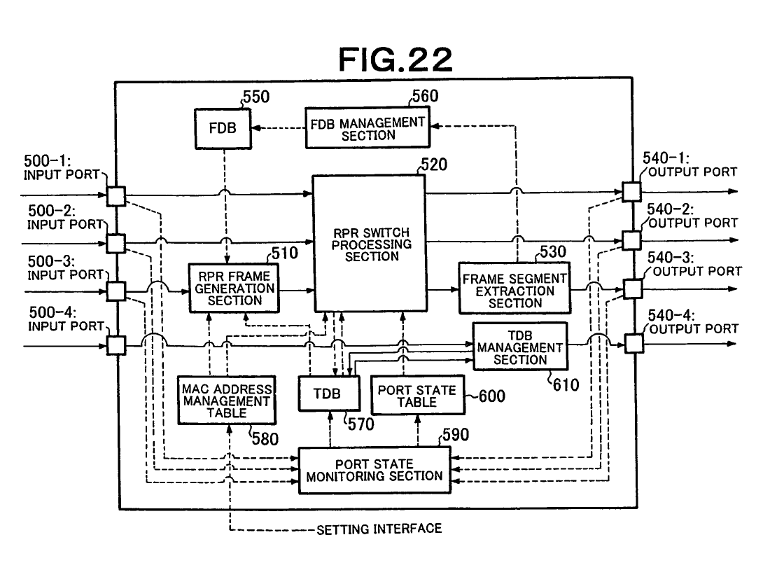

Configurations of the RPR node and a node serving as the dependent terminal of the RPR node will next be described. FIG. 22 is a block diagram showing a configuration example of the RPR node 100 in the present embodiment. Although the RPR node 100 is taken as an example in descriptions below, the same descriptions may apply to the other RPR nodes 110 to 130 and 200 to 230.

As shown in FIG. 22, the RPR node 100 according to the present embodiment differs from the RPR node of the first embodiment in that it further includes an input port 500-4, an output port 540-4, and a TDB management section 610.

The input port 500-4 of the RPR node 100 is a receiving side port (port for receiving frame) in the port P4 of the RPR node 100 shown in FIG. 21. The input port 500-4 is a port for receiving a frame transmitted from an RPR node having the same dependent terminal as the local node has and which belongs to a different RPR network.

The output port 540-4 of the RPR node 100 is a transmitting side port (port for transmitting frame) in the port P4 of the RPR node 100 shown in FIG. 21. The input port 540-4 is a port for transmitting a frame to an RPR node having the same dependent terminal as the local node has and which belongs to a different RPR network.

More specifically, the input port 500-4 of the RPR node 100 receives a frame for notifying topology information of the RPR network 20 which is transmitted from the output port 540-4 of the RPR node 200. The output port 540-4 of the RPR node 100 transmits a frame for notifying topology information of the RPR network 10 to the input port 500-4 of the RPR node 200.

The FDB management section 610 registers in the TDB 570 the topology information of a different RPR network (RPR network to which an RPR node having the same dependent terminal as the local node has belongs) which is received via the input port 500-4 and transmits via the output port 540-4 the topology information of the RPR network to which the local node belongs to an RPR node belonging to a different RPR network.

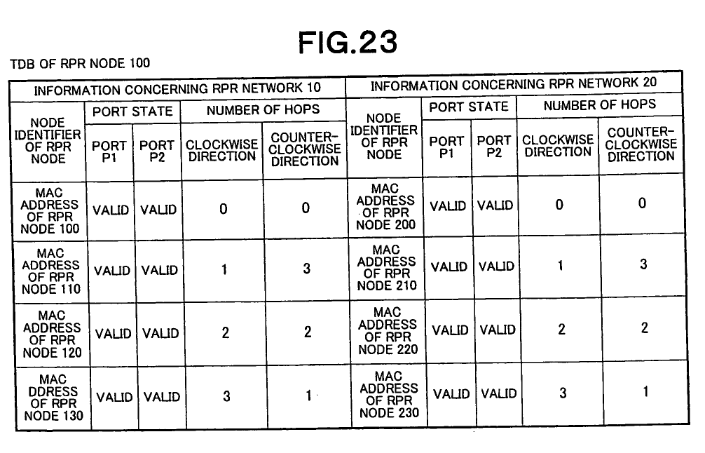

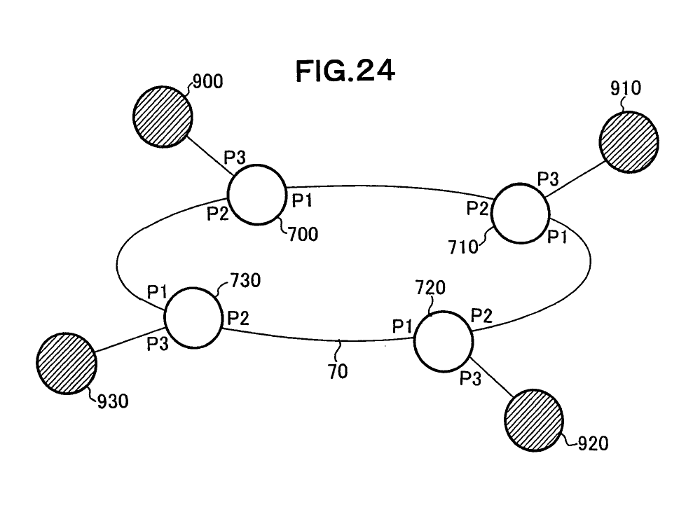

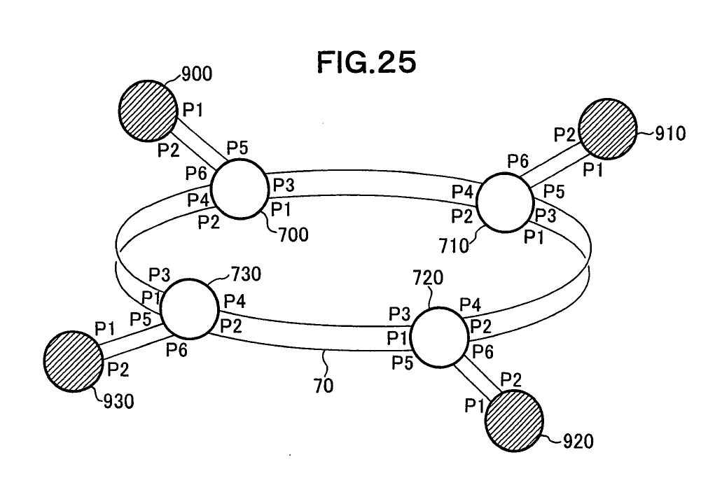

In the present embodiment, the TDB 570 manages the topology information of the RPR network to which an RPR node having the same dependent terminal as the local node has belongs in addition to the topology information of the RPR network to which the local node belongs. FIG. 23 is an explanatory view showing an example of information registered in the TDB 570 of the RPR node 100. As shown in FIG. 23, unlike the first embodiment, the TDB 570 includes not only the information concerning the RPR network 10 but also information concerning the RPR network 20.

The configuration of the node serving as the dependent terminal is the same as that according to the first embodiment.

As described in the above first and second embodiments, according to the present invention, it is possible to flexibly increase the transmission capacity of the entire RPR network at low cost. However, the terminal starts to reconstruct the original Ethernet frame only after receiving all the frame segments generated from the same Ethernet frame, so that delay time may increase due to arrival time difference between the first arriving frame segment and last arriving frame segment in the embodiment described above.

A method for reducing the delay time in the communication system according to the present invention will be described below. A difference of the communication path (including transmission direction) of the frame segment can be cited as one of the factors contributing to the arrival time difference between the frame segments. For example, in the case where one of the frame segments (actually, RPR frames each containing the frame segment) that have been generated from the same Ethernet frame transferred by the RPR network 10 is transmitted in the clockwise direction and the other one thereof transferred by the RPR network 20 is transmitted in the counterclockwise direction, the number of hops to the RPR nodes having the same destination terminal may differ between the RPR networks 10 and 20, thereby causing arrival time difference between the frame segments. In view of this, in order to reduce the arrival time difference between the frame segments, there can be considered a method that transmits the RPR frames containing the frame segments that have been generated from the same Ethernet frame in the same direction.

For example, in the case where all the RPR nodes having the same dependent terminal unicast-transfer the RPR nodes containing the frame segments that have been generated from the same Ethernet frame, a shortest path algorithm is set so that the RPR nodes are transmitted in a direction in which the number of hops to the destination RPR node becomes minimum.

The transmission direction is previously set also for a case where the number of hops becomes the same in both directions so as to allow the RPR nodes having the same dependent terminal to transmit the RPR frames in the same direction.

Further, the transmission direction is previously set for a case where the RPR frames containing the frame segments that have been generated from the same Ethernet frame are broadcast-transmitted so as to allow the RPR nodes having the same dependent terminal to transmit the RPR frames in the same direction. For example, in the case where Unidirectional broadcast method is employed, setting is made such that the transmission directions of the broadcast frames coincide with each other. Further, in the case where Bidirectional Broadcast method is employed, when the value to be set in the TTL differs in the two directions (clockwise direction and counterclockwise direction) depending on the number of nodes, setting is made such that the directions in which the value of the TTL is increased coincide with each other.

As described above, in the normal operation time, the delay time can be reduced by allowing the transmission directions of the RPR frames containing the frame segments that have been generated from the same Ethernet frame to coincide with each other.

As described in the first embodiment, in the case where a link failure or node failure has occurred, the protection function of the RPR works to allow the RPR frame to bypass a failure point. Therefore, at the time of occurrence of a failure, even if the transfer direction control has been made as described above, the communication paths of the frame segments that have been generated from the same Ethernet frame may differ.

To solve the above problem, in the present embodiment, a failure occurring in another RPR network is recognized from the topology information of the another network which is managed by the TDB management section 610 to make the transmission direction of the RPR frame from the local node coincide with the transmission direction in which the RPR node belonging to the network having a failure transmits the RPR frame.

As described above, even in the time of occurrence of a failure, the delay time can be reduced since the transmission directions of the RPR frames containing the frame segments that have been generated from the same Ethernet frame are allowed to coincide with each other.

As another factor contributing to the arrival time difference between the frame segments, a difference of the degree of congestion in the RPR networks can be cited. In the case where no congestion occurs in all the RPR networks, no delay is caused. However, in the case where congestion occurs in a given RPR network, the arrival of the frame segment transferred by the relevant RPR network is delayed to cause delay time. In view of this, in order to reduce the arrival time difference between the frame segments, there can be considered a method that makes the degree of congestion uniform between the RPR networks.

As described in the first embodiment, when the RPR frames have the same frame size, the traffic amounts in the respective RPR networks become the same. Thus, in this case, the above problem can be avoided.

In the case where the transmission capacity differs between the RPR networks 10 and 20, the degree of congestion is made uniform between the RPR networks not by making the sizes of the frame segments that have been generated from the same Ethernet frame equal to each other, but by making the ratio of the size between the frame segments coincide with the ratio of the transmission capacity between the respective RPR networks.

When a configuration is adopted in which the TDB management section 610 includes information indicating the degree of congestion of the RPR network to which the local node belongs in the topology information, the transmission of the RPR frame may be suspended for a certain period of time in accordance with the degree of congestion in another RPR network.

Further, there can be considered a method that provides a means for reporting the congestion state in the RPR node between the RPR node and its dependent terminal and changes the size of the frame segment depending on the availability of free bandwidth or congestion state, or a method that controls the traffic capacity allocated to the respective RPR network so as to reduce the arrival time difference of the frame segments.

As described above, according to the methods described in the present embodiment, the problem of the delay in the first and second embodiments can be solved.

Further, in the above respective embodiments, the RPR node or node includes the respective processing sections such as the RPR frame processing section 510 and Ethernet frame reconstruction section 710, a configuration may be adopted in which the RPR node or node includes a computer which performs the same operation as the above respective processing sections according to a program. In this case, the program is previously stored in a storage device provided in the node.

Frame segment generation means and frame segment distribution means described in the claims are realized by, e.g., the frame segment generation section 730 of the node. Frame reconstruction means is realized by, e.g., the Ethernet frame reconstruction section 710 of the node. Correspondence relationship storage means is realized by, e.g., the FDB 550 of the RPR node and FDB 840 of the node. Intra-network communication frame generation means is realized by the RPR frame generation section 510 and RPR frame generation section 820. Frame segment extraction means is realized by, e.g., frame segment extraction section 530 and FDB management section 560 of the RPR node and frame segment extraction section 810 and FDB management section 830 of the node. Frame segment storage means is realized by, e.g., the frame segment storage table 713 of the node. Frame segment management means is realized by, e.g., the Ethernet frame reconstruction processing section 711 and frame segment storage address management table 714 of the node.

1. A communication system in which a terminal is connected to a plurality of networks, characterized in that
the terminal is connected to a node belonging to each network as a dependent terminal to use the plurality of networks as a communication path,
the terminal comprises:
frame segment generation means for generating a plurality of frame segments obtained by dividing a single frame, each of the frame segments storing a destination node identifier for identifying a destination terminal of the frame and a transmission source node identifier for identifying a transmission source terminal of the frame;
frame segment distribution means for distributing the frame segments generated by the frame generation means to all or part of the nodes to which the terminal is connected and transmitting them; and
frame reconstruction means for reconstructing a frame before division from a plurality of frame segments which are received from a node to which the terminal is connected and which are generated by the frame segment generation means provided in a different terminal from the terminal, and
the node to which the terminal is connected comprises:
correspondence relationship storage means for storing information indicating a correspondence relationship between a terminal and a node to which the terminal is connected as a dependent terminal;
intra-network communication frame generation means for generating, when receiving the frame segment from its dependent terminal, an intra-network communication frame storing the received frame segment in the payload after determining a transfer method or transfer destination node based on the destination node identifier stored in the frame segment and the correspondence relationship between the terminal indicated by the destination node identifier and node which is stored in the correspondence relationship storage means and storing a node identifier for identifying the node as a transmission source address;
frame segment extraction means for extracting the frame segment stored in the payload of the received intra-network communication frame and registering, in the correspondence relationship storage means, information indicating the correspondence relationship between the node indicated by the transmission source address of the intra-network communication frame and terminal indicated by the transmission source node identifier stored in the extracted frame segment; and
topology information management means for managing topology information of a network to which the node belongs and topology information of a network to which another node having the same dependent terminal as the node has belongs.

2.-3. (canceled)

4. The communication system according to claim 1, wherein:
the frame segment generation means adds, to each of the frame segments that store data segment which are generated by dividing a single frame, frame segment information indicating information required for integrating the data segment so as to reconstruct the original frame so as to generate the frame segments.

5. The communication system according to claim 1, wherein:
the frame segment generation means adds, to each of the frame segments, frame segment information including a frame identifier for identifying a frame based on which each of the frame segments is generated and division number information for recognizing the number of frame segments generated from the same frame and division order of the frame segments so as to generate the frame segments.

6. The communication system according to claim 1, wherein:
the frame segment generation means generates the frame segments such that the frame length of each of the frame segments generated from a single frame is proportional to the transmission capacity of a network to which each of the frame segments is transmitted.

7. The communication system according to claim 1, wherein:
the frame segment generation means generates the frame segment such that the frame length of each of the frame segments generated from a single frame has a predetermined value.

8. The communication system according to claim 1, wherein:
the frame segment generation means changes the number of frame segments to be generated based on the availability of a communication link in the network to which a node connected to the terminal belongs.

9. The communication system according to claim 1, wherein:
the frame segment distribution means changes the network to which each of the frame segments is distributed based on the availability of a communication link in the network to which a node connected to the terminal belongs.

10. The communication system according to claim 1, wherein:
the intra-network communication frame generation means deletes part or all of the data which are stored, in an overlapped manner, in all the frame segments generated by dividing a single frame when the data are not deleted by another node that receives any of the frame segments.

11. The communication system according to claim 1, wherein:
when detecting that communication with another node constituting the network to which the local node belongs is disabled, the node notifies its dependent terminal of the corresponding information.

12. The communication system according to claim 1, wherein:
the nodes that belong to different networks and having the same dependent terminal operate such that the intra-network communication frames, which store the frame segments generated from the same frame and which are distributed to the respective different networks, are transferred from the transmission source node to destination node in the same amount of time.

13. The communication system according to claim 1, wherein:
the nodes that belong to different networks and having the same dependent terminal notify each other of topology information indicating the topology of the network to which the each of the nodes belong.

14. The communication system according to claim 13, wherein:
the node determines a transfer path of the intra-network communication frame distributed to the network to which the local node belongs such that the intra-network communication frames, which store the frame segments generated from the same frame and which are distributed to the respective different networks, are transferred from the transmission source node to destination node in the same amount of time based on the topology information of the network to which the local node belongs and topology information of another network to which another node having the same dependent terminal as the local node has belongs.

15. The communication system according to claim 14, wherein:
the node suspends, for a certain period of time, transmission of the intra-network communication frame distributed to the network to which the local node belongs such that the intra-network communication frames, which store the frame segments generated from the same frame and which are distributed to the respective different networks, are transferred from the transmission source node to destination node in the same amount of time.

16. The communication system according to claim 1, wherein:
the frame segment generation means makes the frame lengths of the frame segments generated by dividing a single frame proportional to the transmission capacities of the networks to which the frame segments are distributed.

17. The communication system according to claim 1, wherein:
the frame segment generation means changes the frame lengths of the frame segments generated by dividing a single frame in accordance with the degree of congestion in the respective networks.

18. The communication system according to claim 1, wherein:
the frame segment distribution means distributes the frame segments such that the communication bandwidths of the traffic transmitted to the respective networks are proportional to the transmission capacities of the respective networks.

19. The communication system according to claim 1, wherein:
the frame segment distribution means changes the communication bandwidths of the traffic transmitted to the respective networks in accordance with the degree of congestion in the respective networks.

20. The communication system according to claim 1, wherein:
the frame segment reconstruction means comprises:
frame segment storage means for storing the frame segments; and
frame segment management means for managing the frame segments stored in the frame segment storage means.

21. The communication system according to claim 1, wherein:
the frame segment management means manages the frame segments by associating the transmission source identifier of the frame segments, frame identifier for identifying a frame based on which the frame segments are generated, storage position of the frame segments in the frame segment storage means, and the number of frames of the frame segment that has already been stored in the frame segment storage means from a plurality of frame segments generated from the same frame as the frame segment.

22. A terminal used in a communication system in which the terminal is connected to a plurality of networks, wherein:
the terminal is connected to a node belonging to each network as a dependent terminal to use the plurality of networks as a communication path,
the terminal comprises:
correspondence relationship storage means for storing information indicating a correspondence relationship between a terminal and a node to which the terminal is connected as a dependent terminal;
frame segment generation means for generating a plurality of frame segments obtained by dividing a single frame, each of the frame segments storing a destination node identifier for identifying a destination terminal of the frame and a transmission source node identifier for identifying a transmission source terminal of the frame;
intra-network communication frame generation means for generating, for each frame segment generated by the frame segment generation means, an intra-network communication frame storing the frame segment in the payload after determining a transfer method or transfer destination node based on the destination node identifier stored in the frame segment and the correspondence relationship between the terminal indicated by the destination node identifier and node which is stored in the correspondence relationship storage means and storing a node identifier for identifying a node to which the terminal is connected as a transmission source address;
frame segment distribution means for distributing the intra-network communication frames generated by the intra-network communication frame generation means to all or part of the nodes to which the terminal is connected and transmitting them;
frame segment extraction means for extracting the frame segment stored in the payload of the received intra-network communication frame and registering, in the correspondence relationship storage means, information indicating the correspondence relationship between the node indicated by the transmission source address of the intra-network communication frame and terminal indicated by the transmission source node identifier stored in the extracted frame segment; and
frame reconstruction means for reconstructing a frame before division from a plurality of frame segments extracted by the frame segment extraction means.

23. A terminal used in a communication system in which the terminal is connected to a plurality of networks, wherein:
the terminal is connected to a node belonging to each network as a dependent terminal to use the plurality of networks as a communication path,
the terminal comprises:
correspondence relationship storage means for storing information indicating a correspondence relationship between a terminal and a node to which the terminal is connected as a dependent terminal;
frame segment generation means for generating a plurality of frame segments obtained by dividing a single frame, each of the frame segments storing a destination node identifier for identifying a destination terminal of the frame and a transmission source node identifier for identifying a transmission source terminal of the frame;
intra-network communication frame generation means for generating, for each frame segment generated by the frame segment generation means, an intra-network communication frame storing the frame segment in the payload after determining a transfer method or transfer destination node based on the destination node identifier stored in the frame segment and the correspondence relationship between the terminal indicated by the destination node identifier and node which is stored in the correspondence relationship storage means and storing a node identifier for identifying a node to which the terminal is connected as a transmission source address;
frame segment distribution means for distributing the intra-network communication frames generated by the intra-network communication frame generation means to all or part of the nodes to which the terminal is connected and transmitting them;
frame segment extraction means for extracting the frame segment stored in the payload of the received intra-network communication frame and registering, in the correspondence relationship storage means, information indicating the correspondence relationship between the node indicated by the transmission source address of the intra-network communication frame and terminal indicated by the transmission source node identifier stored in the extracted frame segment; and
frame reconstruction means for reconstructing a frame before division from a plurality of frame segments extracted by the frame segment extraction means.

24. A node used in a communication system in which a terminal is connected to the node belonging to each network as a dependent terminal to use the plurality of networks as a communication path, wherein:
the node to which the terminal is connected comprises:
correspondence relationship storage means for storing information indicating a correspondence relationship between a terminal and a node to which the terminal is connected as a dependent terminal;
intra-network communication frame generation means for generating, when receiving the frame segment from its dependent terminal, an intra-network communication frame storing the received frame segment in the payload after determining a transfer method or transfer destination node based on the destination node identifier stored in the frame segment and the correspondence relationship between the terminal indicated by the destination node identifier and node which is stored in the correspondence relationship storage means and storing a node identifier for identifying the node as a transmission source address;
frame segment extraction means for extracting the frame segment stored in the payload of the received intra-network communication frame and registering, in the correspondence relationship storage means, information indicating the correspondence relationship between the node indicated by the transmission source address of the intra-network communication frame and terminal indicated by the transmission source node identifier stored in the extracted frame segment, and
topology information management means for managing topology information of a network to which the node belongs and topology information of a network to which another node having the same dependent terminal as the node has belongs, wherein
the node transmits the intra-network communication frame based on the topology information such that the intra-network communication frames, which store the frame segments generated from the same frame and which are distributed to the respective different networks, are transferred from the transmission source node to destination node in the same amount of time.

25. A communication method applied to a communication system provided with a plurality of networks, in which a terminal is connected to a node belonging to each network as a dependent terminal to use the plurality of networks as a communication path, said method comprising:
generating a plurality of frame segments obtained by dividing a single frame, each of the frame segments storing a destination node identifier for identifying a destination terminal of the frame and a transmission source node identifier for identifying a transmission source terminal of the frame;
distributing the generated frame segments to all or part of the connected nodes and transmitting them; and
reconstructing a frame before division from a plurality of frame segments which are received from the node;
storing information indicating a correspondence relationship between a terminal and a node to which the terminal is connected as a dependent terminal;
generating, when receiving the frame segment from its dependent terminal, an intra-network communication frame storing the received frame segment in the payload after determining a transfer method or transfer destination node based on the destination node identifier stored in the frame segment and the stored correspondence relationship between the terminal indicated by the destination node identifier and node and storing a node identifier for identifying the node as a transmission source address;
transmitting the intra-network communication frame based on topology information of the network to which each node connected to the terminal located under the transmission source node belongs such that the intra-network communication frames, which store the frame segments generated from the same frame and which are distributed to the respective different networks, are transferred from the transmission source node to destination node in the same amount of time;
and
extracting the frame segment stored in the payload of the received intra-network communication frame and registering information indicating the correspondence relationship between the node indicated by the transmission source address of the intra-network communication frame and terminal indicated by the transmission source node identifier stored in the extracted frame segment.

26. A communication method applied to a communication system provided with a plurality of networks, in which a terminal is connected to a node belonging to each network as a dependent terminal to use the plurality of networks as a communication path, said method comprising:
storing information indicating a correspondence relationship between a terminal and a node to which the terminal is connected as a dependent terminal;
generating a plurality of frame segments obtained by dividing a single frame, each of the frame segments storing a destination node identifier for identifying a destination terminal of the frame and a transmission source node identifier for identifying a transmission source terminal of the frame;
generating, for each generated frame segment, an intra-network communication frame storing the frame segment in the payload after determining a transfer method or transfer destination node based on the destination node identifier stored in the frame segment and the stored correspondence relationship between the terminal indicated by the destination node identifier and node and storing a node identifier for identifying a node to which the terminal is connected as a transmission source address;
distributing the generated intra-network communication frame to all or part of the connected nodes and transmitting them;
extracting the frame segment stored in the payload of the received intra-network communication frame and registering information indicating the correspondence relationship between the node indicated by the transmission source address of the intra-network communication frame and terminal indicated by the transmission source node identifier stored in the extracted frame segment; and
reconstructing a frame before division from the extracted plurality of frame segments.

27. A terminal program product applied to a communication system provided with a plurality of networks, in which a terminal is connected to a node belonging to each network as a dependent terminal to use the plurality of networks as a communication path,
the terminal program allowing a computer to execute:
processing of generating a plurality of frame segments obtained by dividing a single frame, each of the frame segments storing a destination node identifier for identifying a destination terminal of the frame and a transmission source node identifier for identifying a transmission source terminal of the frame;
processing of distributing the generated frame segments to all or part of the nodes to which the terminal is connected and transmitting them; and
processing of reconstructing a frame before division from a plurality of frame segments which are received from a node to which the terminal is connected and which are generated by the frame segment generation means provided in a different terminal.

28. A terminal program product applied to a communication system provided with a plurality of networks, in which a terminal is connected to a node belonging to each network as a dependent terminal to use the plurality of networks as a communication path,
the terminal program allowing a computer having a storage device for storing information indicating a correspondence relationship between a terminal and a node to which the terminal is connected as a dependent terminal to execute:
processing of generating a plurality of frame segments obtained by dividing a single frame, each of the frame segments storing a destination node identifier for identifying a destination terminal of the frame and a transmission source node identifier for identifying a transmission source terminal of the frame;
processing of generating, for each generated frame segment, an intra-network communication frame storing the frame segment in the payload after determining a transfer method or transfer destination node based on the destination node identifier stored in the frame segment and the correspondence relationship between the terminal indicated by the destination node identifier and node which is stored in the storage device and storing a node identifier for identifying a node to which the terminal is connected as a transmission source address;
processing of distributing the generated intra-network communication frames to all or part of the nodes to which the terminal is connected and transmitting them;
processing of extracting the frame segment stored in the payload of the received intra-network communication frame and registering, in the storage device, information indicating the correspondence relationship between the node indicated by the transmission source address of the intra-network communication frame and terminal indicated by the transmission source node identifier stored in the extracted frame segment; and
processing of reconstructing a frame before division from the extracted frame segments.

29. A node program product applied to a communication system provided with a plurality of networks, in which a terminal is connected to a node belonging to each network as a dependent terminal to use the plurality of networks as a communication path, the node program allowing a computer having a storage device for storing information indicating a correspondence relationship between a terminal and a node to which the terminal is connected as a dependent terminal and topology information of a network to which the node belongs and topology information of a network to which another node having the same dependent terminal as the node has belongs to execute:
processing of generating, when receiving the frame segment from its dependent terminal, an intra-network communication frame storing the received frame segment in the payload after determining a transfer method or transfer destination node based on the destination node identifier stored in the frame segment and storage content stored in the correspondence relationship storage means and storing a node identifier for identifying the node as a transmission source address;
processing of extracting the frame segment stored in the payload of the received intra-network communication frame and registering, in the storage device, information indicating the correspondence relationship between the node indicated by the transmission source address of the intra-network communication frame and terminal indicated by the transmission source node identifier stored in the extracted frame segment; and
processing of transmitting the intra-network communication frame based on the topology information such that the intra-network communication frames, which store the frame segments generated from the same frame and which are distributed to the respective different networks, are transferred from the transmission source node to destination node in the same amount of time.

30. A communication system in which a terminal is connected to a plurality of networks, wherein:
the terminal is connected to a node belonging to each network as a dependent terminal to use the plurality of networks as a communication path,
the terminal comprises:
correspondence relationship storage means for storing information indicating a correspondence relationship between a terminal and a node to which the terminal is connected as a dependent terminal;
frame segment generation means for generating a plurality of frame segments obtained by dividing a single frame, each of the frame segments storing a destination node identifier for identifying a destination terminal of the frame and a transmission source node identifier for identifying a transmission source terminal of the frame;
intra-network communication frame generation means for generating, for each frame segment generated by the frame segment generation means, an intra-network communication frame storing the frame segment in the payload after determining a transfer method or transfer destination node based on the destination node identifier stored in the frame segment and the correspondence relationship between the terminal indicated by the destination node identifier and node which is stored in the correspondence relationship storage means and storing a node identifier for identifying a node to which the terminal is connected as a transmission source address;
frame segment distribution means for distributing the intra-network communication frames generated by the intra-network communication frame generation means to all or part of the nodes to which the terminal is connected and transmitting them;
frame segment extraction means for extracting the frame segment stored in the payload of the received intra-network communication frame and registering, in the correspondence relationship storage means, information indicating the correspondence relationship between the node indicated by the transmission source address of the intra-network communication frame and terminal indicated by the transmission source node identifier stored in the extracted frame segment; and
frame reconstruction means for reconstructing a frame before division from a plurality of frame segments extracted by the frame segment extraction means.

31. The communication system according to claim 30, wherein:
the node comprises topology information management means for managing topology information of a network to which the node belongs and topology information of a network to which another node having the same dependent terminal as the node has belongs.

32. The communication system according to claim 30, wherein:
the frame segment generation means adds, to each of the frame segments that store data segment which are generated by dividing a single frame, frame segment information indicating information required for integrating the data segment so as to reconstruct the original frame so as to generate the frame segments.

33. The communication system according to claim 30, wherein:
the frame segment generation means adds, to each of the frame segments, frame segment information including a frame identifier for identifying a frame based on which each of the frame segments is generated and division number information for recognizing the number of frame segments generated from the same frame and division order of the frame segments so as to generate the frame segments.

34. The communication system according to claim 30, wherein:
the frame segment generation means generates the frame segments such that the frame length of each of the frame segments generated from a single frame is proportional to the transmission capacity of a network to which each of the frame segments is transmitted.

35. The communication system according to claim 30, wherein:
the frame segment generation means generates the frame segment such that the frame length of each of the frame segments generated from a single frame has a predetermined value.

36. The communication system according to claim 30, wherein:
the frame segment generation means changes the number of frame segments to be generated based on the availability of a communication link in the network to which a node connected to the terminal belongs.

37. The communication system according to claim 30, wherein:
the frame segment distribution means changes the network to which each of the frame segments is distributed based on the availability of a communication link in the network to which a node connected to the terminal belongs.

38. The communication system according to claim 30, wherein:
the intra-network communication frame generation means deletes part or all of the data which are stored, in an overlapped manner, in all the frame segments generated by dividing a single frame when the data are not deleted by another node that receives any of the frame segments.

39. The communication system according to claim 30, wherein:
when detecting that communication with another node constituting the network to which the local node belongs is disabled, the node notifies its dependent terminal of the corresponding information.

40. The communication system according to claim 30, wherein:
the nodes that belong to different networks and having the same dependent terminal operate such that the intra-network communication frames, which store the frame segments generated from the same frame and which are distributed to the respective different networks, are transferred from the transmission source node to destination node in the same amount of time.

41. The communication system according to claim 30, wherein:
the nodes that belong to different networks and having the same dependent terminal notify each other of topology information indicating the topology of the network to which the each of the nodes belong.

42. The communication system according to claim 41, wherein:
the node determines a transfer path of the intra-network communication frame distributed to the network to which the local node belongs such that the intra-network communication frames, which store the frame segments generated from the same frame and which are distributed to the respective different networks, are transferred from the transmission source node to destination node in the same amount of time based on the topology information of the network to which the local node belongs and topology information of another network to which another node having the same dependent terminal as the local node has belongs.

43. The communication system according to claim 42, wherein:
the node suspends, for a certain period of time, transmission of the intra-network communication frame distributed to the network to which the local node belongs such that the intra-network communication frames, which store the frame segments generated from the same frame and which are distributed to the respective different networks, are transferred from the transmission source node to destination node in the same amount of time.

44. The communication system according to claim 30, wherein:
the frame segment generation means makes the frame lengths of the frame segments generated by dividing a single frame proportional to the transmission capacities of the networks to which the frame segments are distributed.

45. The communication system according to claim 30, wherein:
the frame segment generation means changes the frame lengths of the frame segments generated by dividing a single frame in accordance with the degree of congestion in the respective networks.

46. The communication system according to claim 30, wherein:
the frame segment distribution means distributes the frame segments such that the communication bandwidths of the traffic transmitted to the respective networks are proportional to the transmission capacities of the respective networks.

47. The communication system according to claim 30, wherein:
the frame segment distribution means changes the communication bandwidths of the traffic transmitted to the respective networks in accordance with the degree of congestion in the respective networks.

48. The communication system according to claim 30, wherein:
the frame segment reconstruction means comprises:
frame segment storage means for storing the frame segments; and
frame segment management means for managing the frame segments stored in the frame segment storage means.

49. The communication system according to claim 30, wherein:
the frame segment management means manages the frame segments by associating the transmission source identifier of the frame segments, frame identifier for identifying a frame based on which the frame segments are generated, storage position of the frame segments in the frame segment storage means, and the number of frames of the frame segment that has already been stored in the frame segment storage means from a plurality of frame segments generated from the same frame as the frame segment.
